(19) United States
(12) Patent Application Publication
(10) Pub. No.: US 2026/0113244 A1
(43) Pub. Date: Apr. 23, 2026

(54) DATA ANALYTICS FOR SENSING SERVICES IN NEXT GENERATION CELLULAR NETWORKS

(71) Applicant: Intel Corporation, Santa Clara, CA (US)

(72) Inventors: Zongrui DING, Portland, OR (US); Fatemeh HAMIDI-SEPEHR, San Jose, CA (US); Qian LI, Portland, OR (US); Meghashree Dattatri KEDALAGUDDE, Portland, OR (US); Alexandre Saso STOJANOVSKI, Paris (FR); Thushara HEWAVITHANA, Tempe, AZ (US); Thomas LUETZENKIRCHEN, Taufkirchen (DE); Abhijeet KOLEKAR, Portland, OR (US); Sudeep PALAT, Cheltenham (GB); Youn Hyoung HEO, San Jose, CA (US); Sangeetha L. BANGOLAE, Portland, OR (US)

(21) Appl. No.: 19/117,814

(22) PCT Filed: Nov. 1, 2023
(86) PCT No.: PCT/US2023/078301

§ 371 Date: Apr. 2, 2025

Related U.S. Application Data
(60) Provisional application No. 63/422,350, filed on Nov. 3, 2022.

(51) Int. Cl. H04L 41/14

(52) U.S. Cl. CPC H04L 41/14

(57) ABSTRACT

The present disclosure is related to integrated sensing and communication services, and in particular, to data analytics for integrated sensing and communication services in 3GPP networks. Various input and output parameters related to sensing service analytics are provided by defining the sensing data at different processing stages of various sensing devices. Additionally, a service producer receives, from a service consumer, an analytics identifier (ID) that corresponds to a sensing service and a set of input parameters related to the sensing service. The service producer obtains analytics information based on the analytics ID and the set of input parameters. The service producer sends a second message including the analytics information to the service consumer. Other embodiments may be described and/or claimed.

### CROSS REFERENCE TO RELATED APPLICATIONS

The present application claims priority to U.S. Provisional App. No. 63/422,350 filed Nov. 3, 2022, the contents of which is hereby incorporated by reference in its entirety.

### BACKGROUND

Wireless sensing technologies aim at acquiring information about remote objects and their characteristics without physically contacting such objects. Perception data of the object and its surrounding can be utilized for analysis, so that meaningful information about the object and its characteristics can be obtained.

### BRIEF DESCRIPTION OF THE DRAWINGS

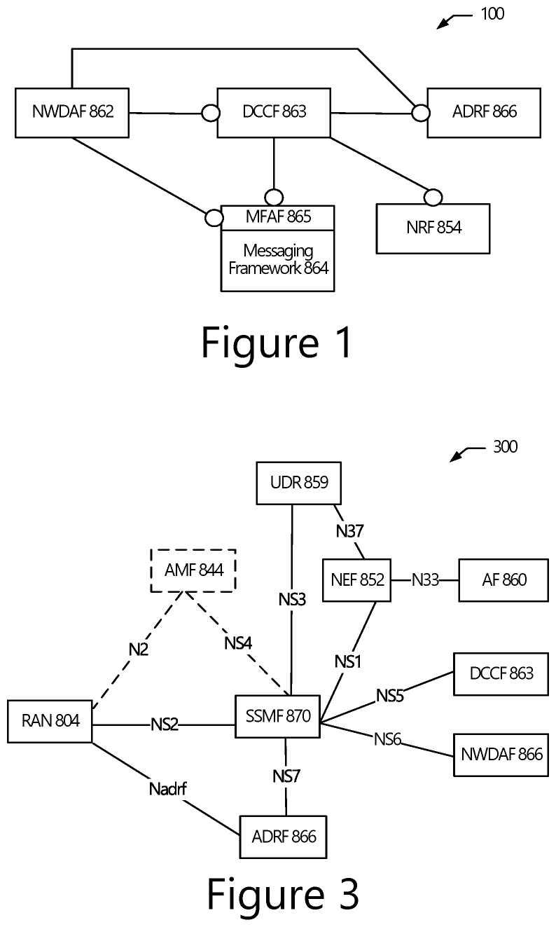

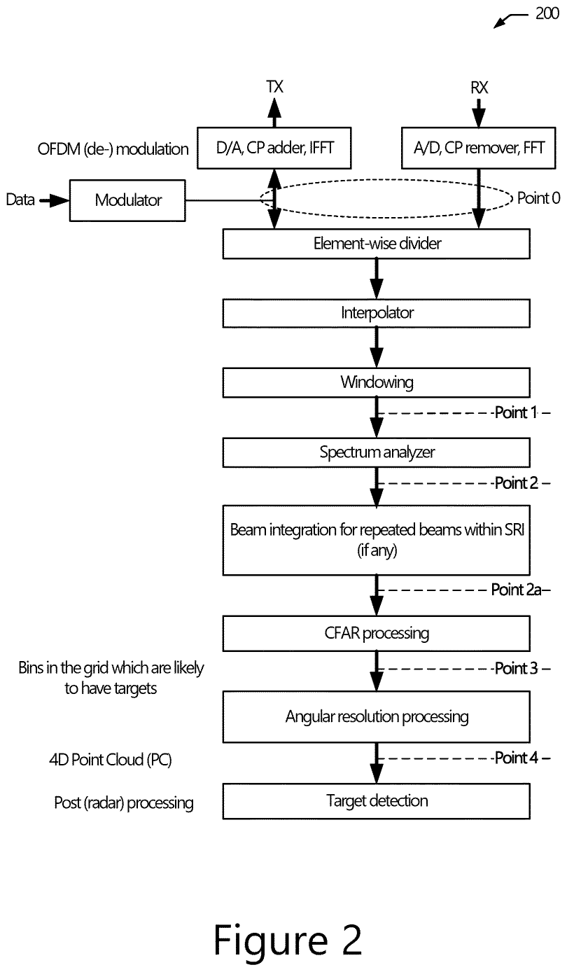

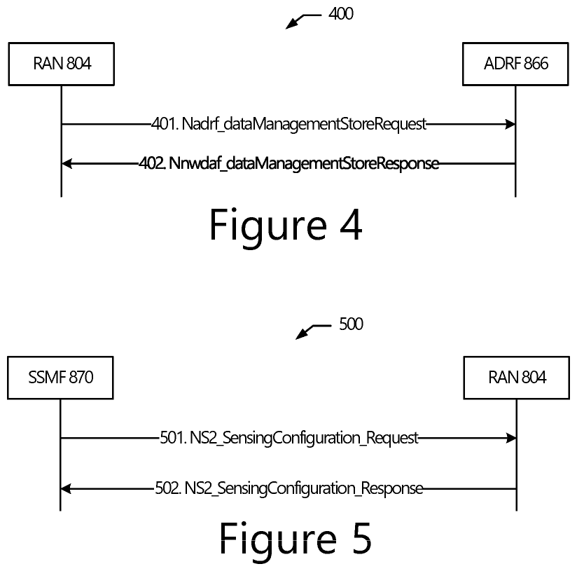

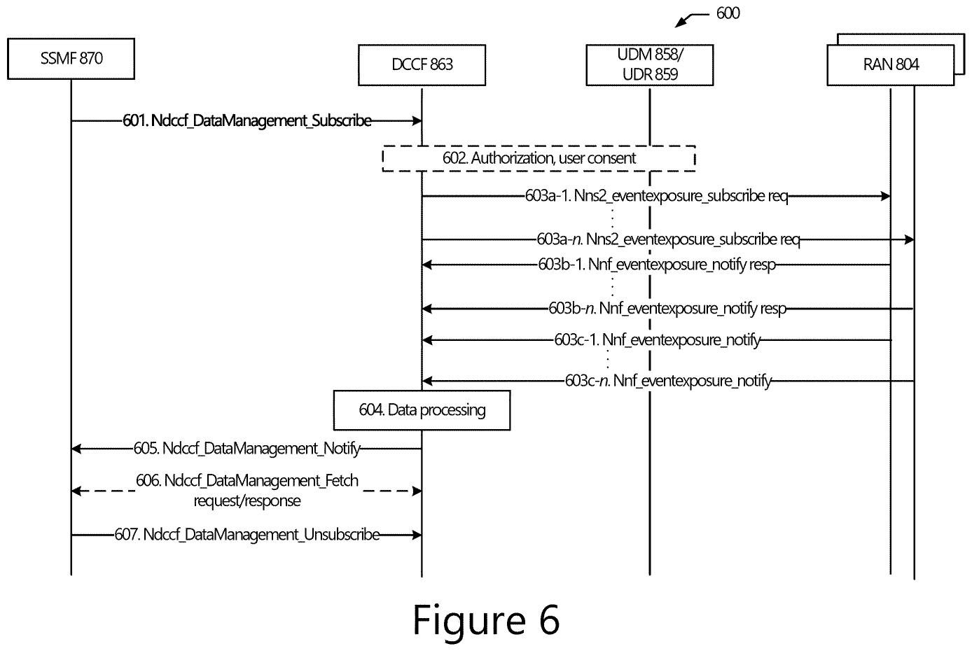

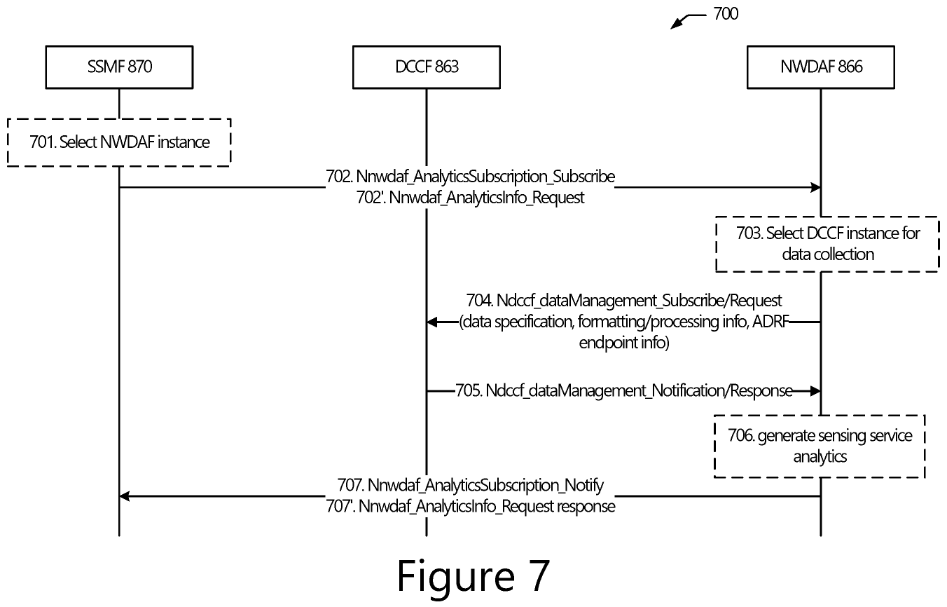

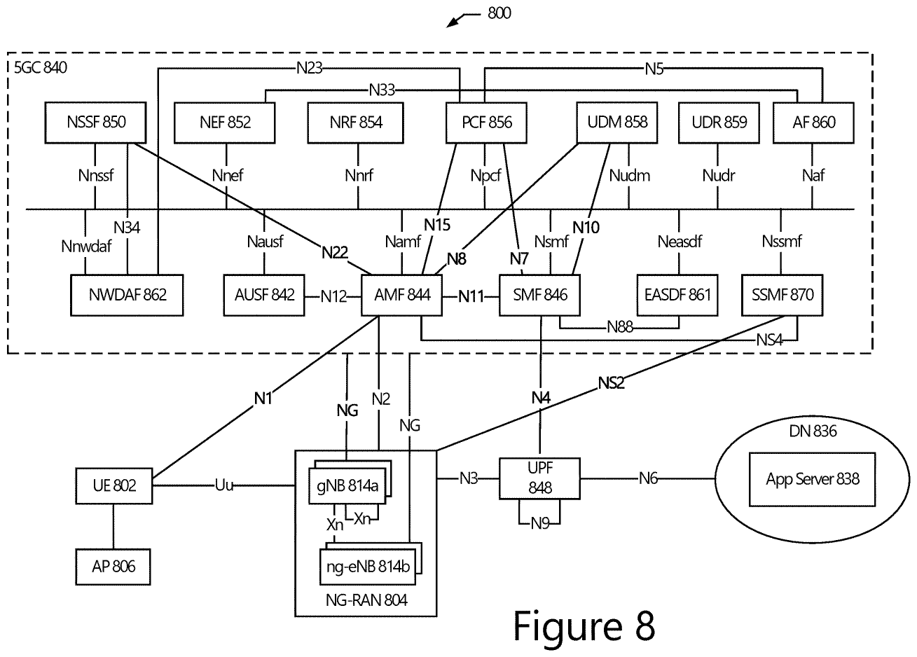

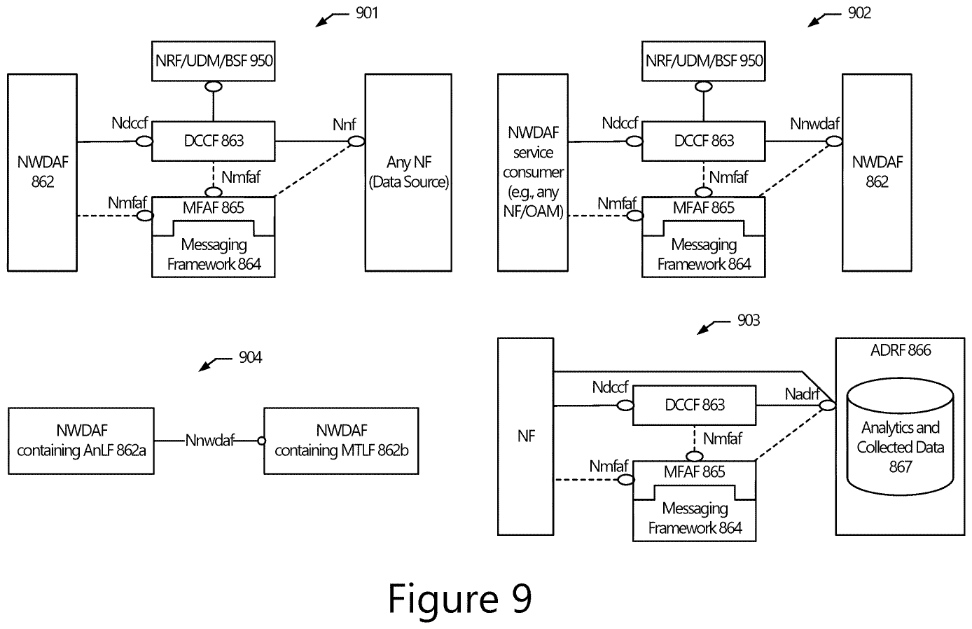

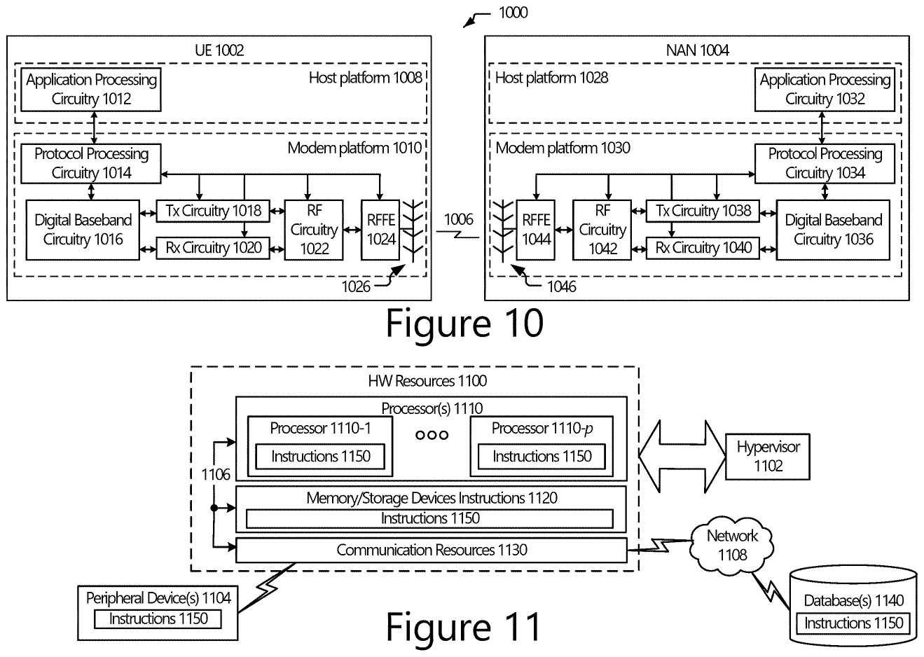

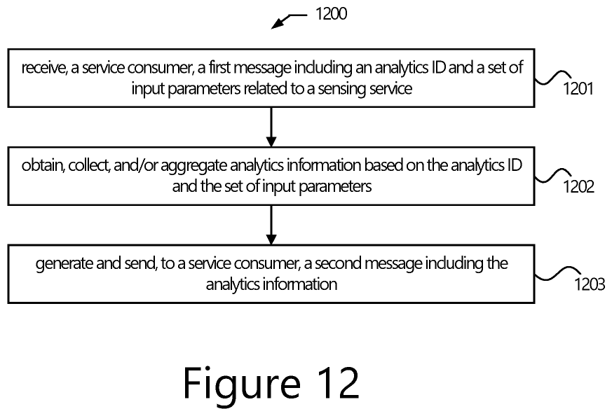

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings in which: FIG. 1 depicts an example data collection coordination function (DCCF)/network data analytics function (NWDAF) architecture; FIG. 2 depicts an example of sensing target detection receiver processing; FIG. 3 depicts an example reference architecture for sensing services; FIG. 4 depicts an example sensing data storage procedure; FIG. 5 depicts an example sensing data collection procedure; FIG. 6 depicts an example for sensing data collection procedure; FIG. 7 depicts an example sensing data analytics retrieval procedure; FIGS. 8 and 10 depict example wireless networks; FIG. 9 depicts various example NWDAF architectures; FIG. 11 depicts example hardware resources; and FIG. 12 depicts an example process for practicing the various embodiments discussed herein.

### DETAILED DESCRIPTION

### 1. Integrated Sensing and Communication Services Aspects

The present disclosure is generally related to wireless communications technologies, cloud computing, edge computing, artificial intelligence (AI) and machine learning (ML), and in particular, to data analytics for integrated sensing and communication services in next generation (NG) networks.

Wireless sensing technologies aim at acquiring information about remote object(s) and their characteristics without physically contacting such object(s). The perception data of the object(s) and their surroundings can be utilized for analysis, so that meaningful information about the object(s) and their characteristics can be obtained. Additionally or alternatively, wireless sensing is a technology enabler to acquire information about characteristics of the environment and/or objects within the environment that uses radio waves to determine the distance (range), angle, and/or instantaneous linear velocity of objects. Example use cases and/or applications of wireless sensing are discussed infra.

Wireless sensing services involve analyzing transmissions, reflections, and/or scattering of wireless sensing signals. Radio detection and ranging (radar) is an example wireless sensing technology that uses radio waves to determine the distance (range), angle, or instantaneous linear velocity of objects. Some sensing technologies include non-radiofrequency (RF) sensors such as, for example, image-forming devices, optical telescopes, time-of-flight (ToF) cameras, accelerometers, gyroscopes, light detection and ranging (lidar), sound/sonic navigation and ranging (sonar), and/or the like.

Integrated sensing and communication services in a 3GPP 5G system (5GS) refers to sensing capabilities that are provided by the same 5G/new radio (NR) wireless communication system and infrastructure as used for communication. The sensing information could be derived from RF-based and/or non-RF based sensors. In general, it could involve scenarios of communication assisted sensing (e.g., where the 5GS provides sensing services) or sensing assisted communication (e.g., when sensing information related to the communication channel or environment is used to improve the communication service of the 5GS itself, such as the sensing information can be used to assist radio resource management, interference mitigation, beam management, mobility, and/or the like). Sensing of wireless communication channels and environment could further improve the performance of communication systems. Some examples of sensing assisted communication scenarios include: sensing a UE's location and channel environment to narrow the beam sweeping range and shorten the beam training time; sensing a UE's location, velocity, motion trajectory, and channel environment for beam prediction, and reducing the overhead of beam measurement and the delay of beam tracking; and/or sensing a UE's property and channel environment to improve the performance of channel estimation.

Integrated sensing and communication technology has the potential to enable new services and use cases for various industries. 5G wireless sensing service, as part of a cellular network, provides new possibilities for enhanced usage of the telecommunication infrastructure in areas of object detection and tracking, environment monitoring and human motion monitoring. It provides input to various verticals, such as unmanned aerial vehicles (UAVs), drones, robotics, smart home, vehicle-to-everything (V2X), smart factories, among many others. The potential use cases that can utilize these sensing services cover a wide range of applications, including: object and intruder detection for smart home, on a highway, for railways, for factory, for predefined secure areas around critical infrastructure; collision avoidance and trajectory tracking of UAVs, vehicles, autonomous ground vehicles (AGVs), vulnerable road users (VRUs), and the like (e.g., which may include animal detection on highways/roadways); automotive maneuvering and navigation; public safety search and rescue; environment monitoring and analysis (e.g., weather (rainfall monitoring and flooding, and/or the like), air pollution monitoring, and/or the like); health and sports monitoring; extended reality (XR) and/or cloud gaming applications; security and/or intrusion detection; among many others.

### 1.1. Data Analytics Sensing Services Aspects

To enable sensing services, a sensing service management function (SSMF) 870 to hold the sensing service logic, algorithms, policies and configurations. As shown by FIGS. 3 and 8, the SSMF 870 interfaces with a radio access network (RAN) 804 via an NS2 interface/reference point, and with an Access and Mobility Management Function (AMF) 844 via an NS4 interface/reference point. The SSMF 870 can also interface with various network functions (NFs) via a newly defined Nssmf service based interface (SBI) to exchange sensing related data and notifications.

To decide the data and its amount exchanged between the RAN 804 and the core network (CN) 840, studies based on typical key performance indicators (KPI) requirements about the sensing service and processing pipelines show that the data amount can be very high per beam per frame up to G bits to T bits if the RAN 804 would send the intermediate processing results to the CN 840. On the other hand, sensing data is very valuable in producing different results, ranging from the basic sensing objectives including detecting objects to objects' shape identification and movement tracking (which are more advanced objectives usually achievable through advanced post processing). Such processing usually requires a large amount of sensing data. Analytics can be generated based on applying AI/ML or post-processing to the sensing data. As discussed in more detail infra, the data collection coordination function (DCCF)/network data analytics function (NWDAF) framework can be leveraged for sensing data collection, transfer, post-processing, and delivery.

### 1.1.1. DCCF and NWDAF Framework

FIG. 1 shows an example DCCF/NWDAF framework 100. FIG. 9 also shows various NWDAF-related architectures. As shown by FIGS. 1 and 9, and as discussed in [TS23288], an NWDAF 862 can include an analytics logical function (AnLF) 862a and a model training logical function (MTLF) 862b. The NWDAF 862 can include one or both functions. The DCCF 863 is responsible for data collection, which could potentially avoid the same data to be collected multiple times, hold data registry, and preprocess collected data, and/or the like. DCCF 863 and/or NWDAF 862 can also work with the analytics data repository function (ADRF) 866 to store data and the messaging framework 864 to efficiently deliver data via an adaptor function Messaging Framework Adaptor Function (MFAF) 865. Additional aspects of these functions are discussed in more detail infra with respect to (w.r.t) FIG. 9.

Network data analytics are identified by analytics identifier (ID) and related information as shown in table 1.1.1-1. The NWDAF 862 can produce multiple analytics related to sensing services, which can be consumed by NFs, such as the SSMF 870 and/or other NFs including any of those discussed herein.

TABLE 1.1.1-1
Analytics information provided by NWDAF

| Analytics | | |
|---|---|---|
| Information | Request Description | Response Description |
| Slice Load level | Analytics ID: load | Load level provided as number of UE registrations |
| information | level information | and number of PDU sessions for a Network Slice |
| | | and Network Slice instances as well as resource |
| | | utilization for Network Slice instances. |
| Observed Service | Analytics ID: | Observed Service experience statistics or |
| experience | Service Experience | predictions may be provided for a Network Slice |
| information | | or an Application. They may be derived from an |
| | | individual UE, a group of UEs or any UE. For |
| | | slice service experience, they may be derived |
| | | from an Application, a set of Applications or |
| | | all Applications on the Network Slice. |
| NF Load | Analytics ID: NF | Load statistics or predictions information for |
| information | load information | specific NF(s). |
| Network | Analytics ID: | Statistics or predictions on the load in an Area |
| Performance | Network Performance | of Interest; in addition, statistics or predictions |
| information | | on the number of UEs that are located in that Area |
| | | of Interest. |
| UE mobility | Analytics ID: | Statistics or predictions on UE mobility. When |
| information | UE Mobility | visited AOI(s) is included in the analytics filter |
| | | information, only statistics on UE mobility can be |
| | | provided. |
| UE Communication | Analytics ID: | Statistics or predictions on UE communication. |
| information | UE Communication | |
| Expected UE | Analytics ID: UE | Analytics on UE Mobility and/or UE |
| behavioural | Mobility and/or UE | Communication. |
| parameters | Communication | |
| UE Abnormal | Analytics ID: | List of observed or expected exceptions, with |
| behaviour information | Abnormal behaviour | Exception ID, Exception Level and other |
| | | information, depending on the observed or |
| | | expected exceptions. |
| End-to-end data | Analytics ID: E2E | Analytics on E2E data volume transfer time. |
| volume transfer time | data volume transfer | |
| | time | |
| User Data | Analytics ID: User | Statistics or predictions on the user data |
| Congestion | Data Congestion | congestion for transfer over the user plane, for |
| information | | transfer over the control plane, or for both. |
| QoS Sustainability | Analytics ID: | For statistics, the information on the location |
| | QoS Sustainability | and the time for the QoS change and the threshold(s) |
| | | that were crossed; or, for predictions, the |
| | | information on the location and the time when |
| | | a potential QoS change may occur and what |
| | | threshold(s) may be crossed. |
| Session | Analytics ID: | Statistics on session management congestion |
| Management | Session Management | control experience for specific DNN and/or |
| Congestion Control | Congestion Control | S-NSSAI. |
| Experience | Experience | |
| Redundant | Analytics ID: | Statistics or predictions aimed at supporting |
| Transmission | Redundant Transmission | redundant transmission decisions for URLLC |
| Experience | Experience | services. |
| WLAN performance | Analytics ID: | Statistics or predictions on WLAN performance |
| | WLAN performance | of UE. |
| Dispersion | Analytics ID: | Statistics or predictions that identify the location |
| | UE Dispersion | (e.g., areas of interest) or network slice(s) where |
| | | a UE, or a group of UEs disperse their data volume, |
| | | or disperse mobility or session management |
| | | transactions or both. |
| DN Performance | Analytics ID: | Statistics or predictions on user plane |
| | DN Performance | performance for a specific edge computing |
| | | application. |
| PFD Determination | Analytics ID: | Statistics on Packet Flow Description (PFD) |
| | PFD Determination | information for a known application identifier(s). |
| Movement Behaviour | Analytics ID: | Statistics or predictions on movement behaviour |
| | Movement Behaviour | for an applicable area. |
| Location Accuracy | Analytics ID: | Predictions on Location Accuracy. |
| | Location Accuracy | |
| Relative Proximity | Analytics ID: | Statistics or predictions on Relative Proximity |
| | Relative Proximity | among UEs and/or detected objects in an |
| | | environment (or applicable area). |
| Sensing | Analytics ID: | Sensing data at different processing stages based |
| Service data | Sensing Service | on location, time window, frequency, update rate, |
| | | refresh rate, detection angle, and/or the like (see |
| | | e.g., FIG. 2 and table 1.1.2-1). |

When a consumer of NWDAF analytics (through analytics subscription or analytics request message(s)) may provide any combination of the analytics IDs in table 1.1.1-1 (e.g., in a list of analytics ID(s) parameter/information element (IE)) to identify the requested analytics to be provided by the NWDAF 862. Additionally, analytics filter information can be provided to the NWDAF 862 in the analytics subscription/request, which indicates the conditions to be fulfilled for reporting analytics information. The analytics filter information can include a set of optional parameter types and values that enables selection of the type of analytics information being requested. Additionally or alternatively, the analytics subscription/request can include a target of analytics reporting (e.g., object(s) for which analytics information is requested), notification target address, analytics reporting information/parameters (e.g., event-based reporting, periodic reporting, reporting frequency, reporting thresholds, matching criteria and/or matching direction, acceptable deviations, update rate, refreshing rate, and/or the like), analytics target period (e.g., including for historical/past and/or future (to be collected) analytics), time window (e.g., time interval for historical analytics), time when analytics information is needed, updated analytics and/or update rate, refreshing rate, sensing service parameters (e.g., object classifications and/or object types to be detected, object tracking information, object shape identification, object mobility information (e.g., range, speed, heading, angular estimates, and/or the like), detection angle, sensing use case/application, and/or any other sensing service information, such as any of those discussed herein). Additional aspects of the analytics subscription/requests and analytics exposure parameters is/are discussed in [TS23288].

The processing of sensing data and/or sensing applications can be different for different types of data, applications, and/or use cases in terms of the objectives. For example, some types of sensing jobs can be categorized as object detection; object range estimation; object mobility (e.g., speed, acceleration, direction/heading, and/or the like) estimation; object angular estimation; object tracking; object shape identification; and/or channel exploitation and channel resolution (e.g., extracting channel parameters as well as characteristics of the environment). Additional or alternative sensing jobs can be defined in other implementations. Different use cases can demand one or multiple of these sensing jobs. For example, a road monitoring use case may demand or desire the object detection, range estimation, mobility estimation, angular estimation, tracking, and shape identification; and a weather monitoring use case may demand or desire the channel resolution job and/or the like. However, this categorization method is not suitable to define sensing related analytics IDs because different use case applications may use different processing algorithms, including even machine learning or deep learning algorithms, which could be implemented as part of the application logic or function logic.

The existing DCCF and NWDAF framework as specified in [TS23288] includes different analytics and events defined, but does not include sensing data-related analytics and events. The current DCCF and NWDAF framework is mainly specified to collect network performance data and user equipment (UE) related data, but does not provide standardized interface(s) to handle sensing related analytics. The present disclosure provides various aspects for sensing related analytics, including defining inputs and outputs for sensing related analytics, and defining the sensing data at different processing stages that can be consumed by different NFs and/or applications.

### 1.1.2. Sensing Data Processing Stages

FIG. 2 shows an example of sensing target detection receiver (Rx) processing 200. The sensing target detection Rx processing 200 includes a transmitter (Tx) chain and an Rx chain. The Tx chain includes a digital-to-analog converter (D/A), a cyclic prefix (CP) adder, and an inverse fast Fourier transform (IFFT); and the Rx chain includes an analog-to-digital converter (A/D), a CP remover, and a fast Fourier transform (FFT). Data is input to a modulator that includes the data in a modulation signal that is used to vary one or more properties of a periodic waveform or carrier signal of the Tx chain. Both the Tx and Rx chains include an element-wise divider, an interpolator, a windowing function/element, a spectrum analyzer, a beam integrator, a constant false alarm rate (CFAR) processor, an angular resolution processor, and a target detector.

The element-wise divider divides the received modulated symbols by the known transmitted modulation symbols to obtain a noisy time-variant frequency-selective channel frequency response (CFR). The interpolator estimates or reconstruct data points at intermediate positions between known data points. The windowing function/element applies a window function (e.g., rectangular, Hamming, Hanning (Hann), Blackman, Gaussian, and/or the like) to the signal to control the shape and/or properties of the signal, which can reduce spectral leakage, suppress side lobes, improve signal-to-noise ratio (SNR), and/or the like.

Range-Doppler (also called delay Doppler) image calculation (e.g., range-Doppler periodogram calculation, range-Doppler profile calculation or the like) includes taking the element-wise divided, interpolated, and windowed received symbols across the OFDM subcarriers and transforming them into the time domain to obtain the range profile, and taking the received symbols across the time domain and transforming them into the frequency domain to obtain the Doppler profile. For example, an Inverse Fast-Fourier Transform (IFFT) of the potentially interpolated and windowed CFR, along the subcarriers provides the range profile, followed by a Fast-Fourier-Transform (FFT) in the (slow) time direction across multiple orthogonal frequency-division multiplexing (OFDM) symbols which provides the Doppler profile. This means that in order to estimate the object's range and speed, the received signal in time-frequency domain is transformed to delay-Doppler domain. (e.g., the two-dimensional (2D) D-D profile). The range-Doppler image is a representation used in radar and remote sensing to visualize and analyze the distance and velocity characteristics of objects or targets within a specific area. The range-Doppler image may combine information about the range (e.g., distance) and Doppler (e.g., velocity or speed) of objects observed by a radar system. In some examples, a range-Doppler image is a two-dimensional (2D) plot, with range on one axis and Doppler on the other axis, which is used to depict the locations and motion characteristics of objects in a radar scene.

The delay-Doppler image includes cells or bins. The bins are used to represent and analyze the distance and velocity characteristics of objects or targets observed by sensing systems (e.g., radar and/or the like). A delay-Doppler image is a 2D space that can combine information about the range (delay) and a Doppler velocity (Doppler) characteristics of objects or targets observed by a sensing (radar) system. The range-Doppler domain provides information about the range (distance) and Doppler velocity (radial velocity) of targets within the radar's FoV. The range (delay) represents the distance between the sensor and the target, which is based on a measured time it takes for a signal to travel to the target and return. The Doppler velocity (or simply “Doppler”) is the radial velocity of the target, which indicates whether the target is moving toward or away from the sensor and the velocity of the movement. The delay-Doppler domain is partitioned into discrete bins or cells along both the range and Doppler dimensions, where each bin represents a specific range and Doppler interval. The granularity of these bins depends on the resolution and requirements of the sensing system. Radar echoes (or echo signals) are analyzed and assigned to the appropriate delay-Doppler bin based on their range and Doppler characteristics. By examining the distribution of echoes within these bins, it is possible to detect and track targets, estimate their positions, velocities, and identify other characteristics.

The beam integrator performs beam integration for repeated beams within an SRI, if any. The CFAR processor performs CFAR processing, which is a signal processing technique commonly used in radar and sonar systems to detect and track targets (objects) while maintaining a constant probability of false alarms. CFAR processing may be used for adaptive thresholding in scenarios where the background noise or clutter levels can vary significantly. Various known CFAR processing techniques can be used in various implementations.

The angular resolution processor determines an angular resolution, which refers to the ability to distinguish between two or more closely spaced objects or targets in terms of their angular positions in the field of view (FoV) of sensor (e.g., radar and/or the like). Different angular resolution algorithms may be used such as, for example, estimation of signal parameters via rotational invariant techniques (ESPRIT), multiple signal classification (MUSIC), constant modulus algorithm (CMA), Capon method, Minimum Variance Distortionless Response (MVDR), Maximum Likelihood Estimation (MLE), iterative sparse asymptotic minimum variance (SAMV), Very-Long-Baseline Interferometry (VLBI), Expectation-Maximization (EM) algorithm, and/or the like. Various known angular resolution processing techniques can be used in various implementations.

The target detection refers to the post-PC processing to identify, track, classify, and/or the like objects of interest (referred to as “targets”) within a radar's FoV or coverage area. The target detection can be based on artificial intelligence (AI) and/or machine learning models/algorithms. Various known target detection techniques can be used in various implementations. The performance of target detection algorithms can be assessed based on several metrics such as, for example, probability of detection (Pd) and probability of false alarm (Pfa), which quantify the system's ability to correctly identify targets while maintaining a low false alarm rate.

In FIG. 2, the echo signal of the sensing signal can be collected at the RAN 804 and/or UE(s) 802 for data processing. In some examples, the information at points 1-4 can be input to generate sensing data analytics. Additionally or alternatively, the information from points 0-4 can be collected from (or by) the SSMF 870 to generate additional or alternative analytics. For example, the output data at different [intermediate] processing stages may be as follows:
(1) Raw received signal, received signal power, and/or other quantities related to the received signal, per beam direction (Point 0).
(2) Noisy time-variant frequency-selective channel frequency response, per beam direction (Point 1). Particularly, the impact of random data is removed by an element-wise division between the known transmitted modulated symbols and the received modulated echoed symbols.
(3) Output of spectral/frequency representation (e.g., periodogram and/or 2D-FFT—An IFFT along the subcarriers provides the range and an FFT in time direction across multiple orthogonal frequency-division multiplexing (OFDM) symbols provides Doppler information) (before beam repetition integration within the symbol repetition interval (SRI) at point 2, or after beam integration at point 2a), per beam direction.
(4) Result of thresholding of the ambiguity function (e.g., result of constant false alarm rate (CFAR) processing) per beam direction (point 3). Since CFAR processing is performed for each of the beams separately, each beam will have its own set of Delay-Doppler bins.
(5) Result of angular resolution processing of Delay-Doppler bins with potential targets in them (e.g., four dimensional point cloud (4D-PC)) (point 4). This stage is normally the maximum processing that the sensor part of a sensing system delivers (e.g., creating the point cloud).

Different equipment used for different use cases, applications, and/or tasks can demand, request, or otherwise access or obtain one or multiple of these outputs (e.g., a road monitoring application may use the output generated at point 3 or point 4, while the weather monitoring application may benefit from the output generated at point 1).

Table 1.1.2-1 shows example dimensioning of generated sensing data at each stage of target detection Rx processing.

TABLE 1.1.2-1

| | Parameters/data that determines | |
|---|---|---|
| | the amount of data at this | Example reference data |
| Point | point of the data flow | size of the smallest unit |
| 1 | Number of REs = [number of | Data size per RE = |
| | TX beams in FoV × (number of | 16I + 16Q (can use |
| | subcarriers within BW × number | this size across all |
| | of OFDM symbols across sensing | interfaces for relative |
| | frame) × number of RX ports] | comparison) |
| 2 | number of beams in FoV × grid | Data size per bin in the |
| | size × number of RX ports = | grid = 16I + 16Q |
| | [number of beams × (Range | |
| | FFT size × Doppler FFT size) × | |
| | number of RX ports] | |
| 2a | Effective number of beams × grid | Data size per bin in the |
| | size × number of RX ports = | grid = 16I + 16Q |
| | [number of beams in FoV × | |
| | (Range FFT size × Doppler FFT | |
| | size × number of repetition of | |
| | each beam in SRI) × number of | |
| | RX ports] | |
| 3 | number of bins with potential | Data size per bin in the |
| | targets in them for each direction × | grid = 16I + 16Q |
| | number of beams in FoV × number | |
| | of RX ports (with each potential | |
| | target's range/Doppler info - | |
| | included in each bin's data) | |
| 4 | number of potential targets in FoV | Data size per point in |
| | (with each target's Range/ | 4D PC = 16 bits |
| | Doppler/Angle info - included in | |
| | each point of PC's data) | |

### 1.1.3. Sensing Data Analytics

The DCCF/NWDAF framework (see e.g., section 1.2) is leveraged for sensing services for sensing data collection, processing, and analytics generation. Based on different sensing use cases, application, and/or data processing stages, multiple sensing analytics IDs can be used, such as those shown by table 1.1.3-1.

TABLE 1.1.3-1
Sensing related Analytics IDs

| Analytics | | |
|---|---|---|
| Information | Request Description | Response Description |
| Sensing Channel | Analytics ID: Sensing | Channel Frequency Response per |
| Frequency Response | Channel Frequency | transmit beam direction, over |
| | Response | all REs used for sensing signal |
| | | transmission |
| Periodogram | Analytics ID: Range- | Range-Doppler image (2D- |
| | Doppler image (2D- | Periodogram (ambiguity function) |
| | Periodogram) | calculated over the delay- |
| | | Doppler grid), per transmit |
| | | beam direction |
| Periodogram after | Analytics ID: Range- | Range-Doppler image after beam |
| beam integration | Doppler image after | integration (e.g., taking into |
| | beam integration | account each beam's repetition), |
| | | per transmit beam direction |
| Delay-Doppler bins | Analytics ID: Delay- | Delay-Doppler bins in 2D grid |
| after CFAR per beam | Doppler bins after | which pass certain CFAR threshold |
| direction | CFAR per beam direction | and are likely to have target(s) in |
| | | them, per transmit beam direction |
| Sensing results for | Analytics ID: Detected | Detected targets in FoV (e.g., |
| detected targets in | targets in FoV | existence detection, range, |
| FoV | | velocity, and/or angle information |
| | | for each target) |

Input and output parameters for each of the analytics ID in table 1.1.3-1 are provided in tables 1.1.3-2 to 1.1.3-11, respectively.

TABLE 1.1.3-2
input information for stage 1 processing (sensing
processing chain) (see e.g., point 1 in FIG. 2)
Analytics ID: Sensing Channel Frequency Response

| Set # | Input Information | Source | Description |
|---|---|---|---|
| 1 | Information related to sensing | RAN | |
| | use case's KPIs | | |
| | >Field of view and/or angle of | RAN | The angular area covered |
| | view (degrees) | | by the sensing job |
| | >Maximum desired detectable | RAN | |
| | range | | |
| | >Maximum desired detectable | RAN | |
| | velocity | | |
| | >Range resolution | RAN | |
| | >Velocity resolution | RAN | |
| | >Angle resolution | RAN | |
| 2 | Information related to sensing | RAN | |
| | radio signal's time, | | |
| | frequency, spatial domain, | | |
| | (and hardware) resources | | |
| | >Overall sensing block/frame | RAN | |
| | duration | | |
| | >Overall sensing radio bandwidth | RAN | |
| | >Number and index of symbols in | RAN | OFDM symbols for sensing |
| | a frame used for signal | | radio signal |
| | transmission | | |
| | >Number and index of subcarriers | RAN | |
| | in the bandwidth used for signal | | |
| | transmission | | |
| | >number of Tx antenna elements | RAN | The number of Tx antenna |
| | | | elements |
| | >number of Tx ports | RAN | For example, if one single Tx |
| | | | port is assumed, one beam is |
| | | | transmitted at a time, with |
| | | | one or multiple (e.g., 4) Tx |
| | | | elements. That port may use |
| | | | all SCs |
| | >number of Rx antenna elements | RAN | The number of Rx antenna elements |
| | >number of Rx ports | RAN | Depending on whether beamforming |
| | | | is performed or not, number of |
| | | | RX ports can be number of receive |
| | | | beams or number of Rx elements |
| | >transmit beam directions to | RAN | The number of transmit beams. The |
| | cover FoV (within SRI) | | number of beams to cover FoV, |
| | | | depends on number of Tx antenna |
| | | | elements, and can be computed with |
| | | | antenna diagram calculation. |
| 3 | Information related to content | RAN | The original sensing signal from |
| | of sensing radio signal | | sender (e.g., a BS or NAN) |
| | >Transmitted modulated symbols | RAN | |
| 4 | Information related to content | RAN | The echoed sensing signal from |
| | of echoed and received sensing | | target(s) and received (e.g., by |
| | radio signal | | a BS or NAN) |
| | >Received modulated symbols | RAN | |
| 5 | Information related to any | RAN | |
| | interpolation and/or windowing | | |
| | procedure | | |
| | Interpolation and/or windowing | RAN | |
| | parameters | | |

In some examples, the information related to a sensing radio signal's time, frequency, and spatial resources may be derived based on the sensing use case KPIs. However, it could be beneficial to separately include all such information since there can be several implementation and architectural aspects which may also impact the derivation/dimensioning of resources. For example, the number of beams to cover a desired field of view (FoV) could also depend on the number of transmitter (Tx) antenna elements, and can be computed with antenna diagram calculation.

TABLE 1.1.3-3
Output information for Stage 1 processing (see e.g., point 1 in FIG. 2)
Analytics ID: Sensing Channel Frequency Response

| Output Information | Description |
|---|---|
| >Channel Frequency | Noisy time-variant frequency- |
| Response per transmit | selective channel frequency |
| beam direction, over | response, per beam direction. |
| all REs used for | Particularly, the impact of |
| sensing signal | random data is removed by an |
| transmission | element-wise division between |
| | the known transmitted modulated |
| | symbols and the received |
| | modulated echoed symbols. |
| >REs used per beam | Subcarriers within the configured |
| direction, including | sensing bandwidth and OFDM |
| potential beam | symbols across sensing frame |
| repetitions within SRI | |
| >transmit beam | |
| directions to cover | |
| the FoV (within SRI) | |
| >number of RX ports | |
| >number of Rx antenna | |
| elements | |

TABLE 1.1.3-4
Input information for Stage 2 processing (see e.g., point 2
in FIG. 2)Analytics ID: Range-Doppler image (2D-Periodogram)

| Input Information | Source | Description |
|---|---|---|
| >Channel Frequency Response per | RAN/SSMF | |
| transmit beam direction, over | | |
| REs used for sensing signal | | |
| transmission | | |
| >REs used per beam direction, | RAN | Subcarriers within the configured |
| including potential beam | | sensing bandwidth and OFDM symbols |
| repetitions within SRI | | across sensing frame |
| >transmit beam directions to | RAN | |
| cover the FoV (within SRI) | | |
| >number of Rx ports | RAN | |
| >number of Rx antenna elements | RAN | |
| Set 1 and Set 2 in Table 1.1.3-2 | RAN | |

In some examples, some or all of the information of set 1 and set 2 in table 1.1.3-2 can be include for inputs to some or all of the processing stages.

TABLE 1.1.3-5
Output information for Stage 2 processing (see e.g., point 2 in FIG. 2)
Analytics ID: Range-Doppler image (2D-Periodogram)

| Output Information | Description |
|---|---|
| >Range-Doppler image (2D-Periodogram | Grid size = Range FFT |
| (ambiguity function) calculated over | size × Doppler FFT size |
| the delay-Doppler grid), per transmit | |
| beam direction | |
| >Range FFT size | |
| >Doppler FFT size | |
| >transmit beam directions to cover | |
| the FoV (within SRI) | |
| >number of beam repetitions for each | |
| beam within SRI | |
| >number of Rx ports | |
| >number of Rx antenna elements | |

TABLE 1.1.3-6
input information for Stage 2a processing
Analytics ID: image after integration

| Input Information | Source | Description |
|---|---|---|
| >Range-Doppler image (2D- | RAN/SSMF | |
| Periodogram calculated over | | |
| the delay-Doppler grid), | | |
| per transmit beam direction | | |
| >Range FFT size | RAN | |
| >Doppler FFT size | RAN | |
| >transmit beam directions | | |
| to cover the FoV (within SRI) | | |
| >number of beam repetitions | RAN | Needed for beam |
| for each beam within SRI | | integration |
| >number of RX ports | RAN | |
| >number of Rx antenna elements | RAN | |
| Set 1 and Set 2 in Table 1.1.3-2 | RAN | |

TABLE 1.1.3-7
Output information for Stage 2a processing image after beam integration
Analytics ID: Range-Doppler image after beam integration

| Output Information | Description |
|---|---|
| >Range-Doppler image after beam | 2D-Periodogram calculated over the |
| integration (e.g., taking into | delay-Doppler grid. |
| account each beam's repetition), | Grid size = Range FFT |
| per transmit beam direction | size × Doppler FFT size |
| >Range FFT size | |
| >Doppler FFT size | |
| >transmit beam directions to cover | |
| the FoV (within SRI) | |
| >number of Rx ports | |
| >number of Rx antenna elements | |

TABLE 1.1.3-8
input information for Stage 3 processing
Analytics ID: Delay-Doppler after CFAR beam direction

| Input Information | Source | Description |
|---|---|---|
| >Range-Doppler image after | RAN/SSMF | 2D-Periodogram |
| beam integration (e.g., | | calculated over |
| taking into account each | | the delay-Doppler |
| beam's repetition), per | | grid |
| transmit beam direction | | |
| >Range FFT size | RAN | |
| >Doppler FFT size | RAN | |
| >transmit beam directions | RAN | |
| to cover the FoV (within | | |
| SRI) | | |
| >number of RX ports | RAN | |
| >number of Rx antenna | RAN | |
| elements | | |
| >CFAR processing parameters, | RAN/SSMF | |
| e.g., threshold, etc. | | |
| Set 1 and Set 2 in Table | RAN | |
| 1.1.3-2 | | |

TABLE 1.1.3-9
Output information for Stage 3 processing
Analytics ID: Delay-Doppler bins after CFAR per beam direction

| Output Information | Description |
|---|---|
| >Delay-Doppler bins in | Result of thresholding of the |
| 2D grid which pass | periodogram, e.g., result of |
| certain CFAR threshold | CFAR processing, per beam |
| and are likely to have | direction. Since CFAR processing |
| target(s) in them, per | is performed for each of the beams |
| transmit beam direction | separately, each beam will have its |
| | own set of Delay-Doppler bins. |
| >Range FFT size | |
| >Doppler FFT size | |
| >transmit beam directions | |
| to cover the FoV (within | |
| SRI) | |
| >number of Rx ports | |
| >number of Rx antenna | |
| elements | |

TABLE 1.1.3-10
input information for Stage 4 processing
Analytics ID: Detected targets in FoV

| Input Information | Source | Description |
|---|---|---|
| >Delay-Doppler bins in 2D grid which | RAN/SSMF | |
| pass certain CFAR threshold and are | | |
| likely to have target(s) in them, | | |
| per transmit beam direction | | |
| >Range FFT size | RAN | |
| >Doppler FFT size | RAN | |
| >transmit beam directions to cover | RAN | |
| the FoV (within SRI) | | |
| >number of Rx ports | RAN | |
| >number of Rx antenna elements | RAN | |
| Angular resolution algorithm and | RAN/SSMF | Examples of angular resolution algorithms |
| corresponding parameters. | | include ESPRIT, MUSIC, CMA, Capon |
| | | method, MVDR, MLE, SAMV, VLBI, EM, |
| | | and/or the like, and/or the like. |
| Set 1 and Set 2 in Table 1.1.3-2 | RAN | |

TABLE 1.1.3-11
Output information for Stage 4 processing
Analytics ID: Detected targets in FoV

| Output Information | Description |
|---|---|
| Detected targets in FoV | Based on different use cases, the |
| (existence detection, and | target can be different which may |
| range, velocity, angle | be input for SSMF to further generate |
| information for each target) | sensing results |

Regarding the dependency of the generated data and its size on the targets' distribution in the environment to be sensed, at the earlier steps of detection processing, data size dimensioning depends on the number of resource elements (REs) used for transmission of sensing radio signal which is defined by the number of subcarriers and the number of OFDM symbols in the frame, used for transmission of the signal, and subsequently, the number of Delay-Doppler bins in the 2D grid evaluated for the existence of potential targets, which is defined by the range and Doppler FFT sizes.

While dimensioning the number of REs and bins is relatively straightforward, towards the later steps of the target detection processing chain (e.g., after CFAR) the data size dimensioning becomes dependent on the environment. For example, the number of potential targets in certain direction and in the entire Field of View (FoV), is dependent on the environment. As such, if one intends to base the dimensioning on the number of targets, then another parameter with respect to the number of bins which are impacted by each target, also comes into the picture. However, usually, it is not feasible to resolve that level of information. Particularly, statistics of targets, including distribution of targets, the number of targets, and targets' sizes (e.g., compared to the bin size, and the number of bins it occupies, etc.), all play a role in the data size dimensioning, and are dependent on the environment.

### 1.2. DCCF/NWDAF Framework for Sensing Services

The present disclosure provides sensing service related identifiers and information elements (IEs) (e.g., analytics ID, sensing data filter, and sensing event IDs) for the SSMF 870 to leverage the NWDAF/DCCF framework to collect, process, transfer, and retrieve sensing data. Example messages and/or communication procedure are provided between the SSMF 870 and NWDAF 862, DCCF 863, and ADRF 866 via newly defined interfaces (e.g., NS2, NS4, NS5, NS6, and/or NS7).

### 1.2.1. Architecture for Sensing Data Collection, Delivery and Processing Using DCCF/NWDAF Framework

FIG. 3 depicts an example sensing service reference architecture 300. In addition to the functionality discussed infra w.r.t FIGS. 8-nw and/or as discussed in [TS23501], the NFs in FIG. 3 may include the following additional functionality.

The AF 860 makes requests for sensing data/information (e.g., sensing type, geographical area, context, data ranges, and/or the like), and collects sensing results.

The NEF 852 authorizes the AF requests with the UDR 859, for example, by using the Common API Framework for 3GPP northbound APIs (CAPIF) defined in [TS23222]; finds a suitable SSMF 870 (or multiple SSMFs 870) based on the information in the AF request (e.g., geo area); and/or relays messages between the AF 860 and the SSMF(s) 870.

The sensing service management function (SSMF) 870 maps the geographical area in the request to a set of RAN node IDs (e.g., gNB IDs and/or the like; see e.g., [TS38300]), possibly taking service area restrictions into account, and generates and sends sensing requests towards the selected RAN nodes 814 (e.g., gNBs 814a) including information, such as required resolution, use of specific sensing algorithms, and/or other data/information. The SSMF 870 also collects input from RAN nodes 814 (e.g., gNBs 814a), processes the input data, and delivers a grouped response towards the AF 860. This could involve re-using the same information for reporting to multiple AFs 860. Additionally or alternatively, the SSMF 870 may have an interface with the UDR 859 (e.g., the NS3 interface/reference point in FIG. 3) for fetching configuration data.

The RAN 804 (or individual RAN nodes 814) receives sensing requests from the SSMF 870 and performs the actual sensing on the radio (e.g., channels, frequency bands/ranges, BWPs, and/or the like). For example, the actual sensing on the radio can involve the RAN 804 scanning the environment by transmitting radio signal(s) in desired and/or selected direction(s), and receiving and processing respective echoes. In some examples, the RAN 804 uses dedicated resources for the network-based sensing functionality. Additionally or alternatively, the RAN 804 can dynamically adjust the amount of dedicated resources for network-based sensing based on the number of ongoing requests, as well as the corresponding resource requirements to meet sensing KPIs for each request. Examples of the sensing KPIs include accuracy of positioning estimate, accuracy of velocity estimate, confidence level, sensing resolution, missed detection probability, false alarm probability and/or CFAR, max sensing service latency, and refreshing rate. Additional or alternative KPIs can be used, such as any of those mentioned herein. Additionally or alternatively, the RAN 804 can configure one or more UEs 802 (see e.g., FIG. 8) to perform the actual sensing on the radio, and the configured UEs 802 can report their respective sensing results to the RAN 804. The RAN 804 delivers the sensing results (e.g., as collected/performed by the RAN 804 and/or by the UEs 802) to the SSMF 870.

The AMF 844 can be used for relaying sensing-related messages between the SSMF 870 and the RAN 804 in case there is no service-based Nran (or NG) interface. If there is a service-based interface between the RAN 804 and the SSMF 870, the sensing-messages are exchanged directly via the NS2 reference point (e.g., via the Nran (or NG) and Nssmf service-based interfaces).

In some examples, the existing N33 interface between the NEF 852 and the AF 860 is enhanced to support the following functionality specific to sensing: 5GS capability for network-based sensing, new data in the AF request, and/or new data in the response to the AF 860. The 5GS capability for network-based sensing can include, for example, sensing types supported and supported QoS levels. Examples of the sensing types can include the following: object detection; object range estimation; object mobility (e.g., speed, acceleration, direction/heading, and/or the like) estimation; object angular estimation; object tracking; object shape identification; and/or channel exploitation and channel resolution (e.g., extracting channel parameters as well as characteristics of the environment). The new data in the AF request can include, for example, the sensing type requested, geo area, start and end time, reporting modes (e.g., periodic, event-based, and/or the like), frequency of reporting, and/or the like. The new data in the response to the AF 860 can include, for example, geo area, sensing results (e.g., colored 2D map indicating rainfall intensity), and/or other information/data.

The NS2 reference point between the SSMF 870 and the RAN 804 is enhanced to support the following functionality specific to sensing: RAN node capability indication (e.g., supported sensing types, QoS levels, and/or the like); data in the SSMF request to the RAN 804 may include, for example, sensing type requested, reporting mode requested (e.g., periodic, event-based), frequency of reporting; and/or data in the RAN response to SSMF 870 may include, for example, detected object shape, detected object velocity, environmental information/data (e.g., air pollution info, rain intensity, and/or the like), and/or other information/data.

In case the messages exchanged between the SSMF 870 and the RAN 804 are relayed via the AMF 844, then the sensing-specific functionality listed above is carried between the AMF 844 and the RAN 804 via the NGAP protocol (see e.g., 3GPP TS 38.413) in appropriate container(s).

As alluded to previously, the SSMF 870 controls sensing services and interfaces with the RAN 804 directly or via the AMF 844. Additionally, the interface between the SSMF 870 and the DCCF 863, between the SSMF 870 and the NWDAF 862, and between the SSMF 870 and the ADRF 866 include the NS5, NS6, and NS7 interfaces, respectively. The RAN 804 interfaces with the ADRF 866 via an Nadrf SBI and/or via the N2 interface through the AMF 844. Additionally or alternatively, the RAN 804 can connect to the CN SBA via an N2′ interface, which is reference point enhanced from the N2 interface, so that the RAN 804 can consume ADRF services; connect to a collocated ADRF in RAN via Nadrf; and/or connect to a new SBI between the RAN 804 and the ADRF 866 to consume ADRF services while the N2 interface/reference point remains as-is.

Similar to the CN SBA, producer functions/NFs register to the NRF 854 (see e.g., FIG. 8) about its services with related parameters, identifiers, data, and/or analytics filters introduced in section 1.2.2 so that the consumer functions/NFs can discover services and/or analytics producer(s) using the identifiers, data, and/or analytics filters.

### 1.2.2. Sensing Data Identifiers

Sensing data identifiers, such as analytics ID, sensing event ID, sensing data filters, and/or the like are the information that describes sensing data, provides labels and/or metadata for sensing data, and/or can be used to retrieve sensing data. As shown by Table 1.1.1-1 (supra), a new analytics ID (or multiple analytics IDs) can be added to the analytics information provided by NWDAF 862. This new analytics ID includes a sensing service analytics ID, which is used for obtaining sensing data in or by the NWDAF 862. In some examples, there can be multiple analytics IDs related to sensing services based on different use cases, such as any of the various use cases discussed herein.

Additionally, sensing data filter parameters can also be defined to collect, describe and retrieve the sensing data and analytics. These sensing data (filter) parameters can also be referred to as “metadata for sensing service” or the like, and can be used by DCCF 863 for data collection, ADRF 866 for data storage, NWDAF 862 for analytics related processing (e.g., NWDAF-AnLF 862a), and/or the like.

TABLE 1.2.2-1
Metadata for Sensing Service

| Parameter | Description |
|---|---|
| Covered Location | The location of the sensing job. In some examples, |
| | the coverage location may be defined as a center |
| | point (e.g., latitude and longitude, or using some |
| | other coordinate system) and radius and/or angle |
| | from the center point. Can also be referred to as |
| | “target sensing service area”, and/or |
| | “sensing service area”, and/or the like. |
| | Can also include moving target service area for |
| | mobile sensing targets. |
| Mode | Mode of the sensing service and/or sensing |
| | measurement process (e.g., NW based, UE based, |
| | UE + NW based, and/or the like). |
| Timestamp | Time when the (sensing) data is collected and/or |
| | when a sensing job (or sensing measurement |
| | process) started and/or ended/ |
| update rate | How often the sensing job is repeated |
| sender location | The sender location of the sensing signal. Can |
| | also be referred to as “transmitter location”, |
| | “Tx location”, “sensing Tx location”, |
| | and/or the like. |
| receiver location | The receiver location of the sensing signal. Can |
| | also be referred to as “Rx location”, and/or |
| | “sensing Rx location”, and/or the like. |
| Field of View | The field of view (FoV) of the sensing signal |
| Sensing resolution | Precision of sensing |
| Data type | The data type, processing point at collection, |
| | (see e.g., FIG. 2) |
| Data amount | The total amount of data |
| Recommended | Purpose of the sensing job (e.g., object detection; |
| purpose | object range estimation; object mobility (e.g., |
| | speed, acceleration, direction/heading, and/or the |
| | like) estimation; object angular estimation; object |
| | tracking; object shape identification; channel |
| | exploitation; channel resolution; and/or the like). |
| | In some examples, relevant use case(s) can also be |
| | included in/with this parameter. |
| Confidence level | The confidence level of the data |

Sensing event IDs can be defined to allow other NFs to be notified about the events and request (ed) data for a specific event related to sensing. The event notifications can be sent among RAN 804, SSMF 870 and NWDAF 862, DCCF 863, ADRF 866, and/or NRF 854 and work as a trigger for other process. Examples of event IDs and NF consumers (NFc) are listed in table 1.2.2-2.

TABLE 1.2.2-2
Event IDs for Sensing Service

| | Event parameter | | | Example |
|---|---|---|---|---|
| Event | name | Parameter values | Attributes | consumer NF |
| Sensing target | Sensing target | Detected | Indicator for whether | SSMF, DCCF, |
| status update | indicator | Not detected | target is detected or not | NWDAF |
| | | Detection error | | |
| Sensing target | Sensing target | Sensing target move in | Indicates sensing target | SSMF, DCCF, |
| mobility | movement | or out of a region | moves to a different | NWDAF |
| | | | region; indicates | |
| | | | sensing target moves | |
| | | | into the region | |
| Sensing | Sensing | 1. The required or desired | Indicates changes in | RAN, SSMF |
| configuration | configuration | sensing KPIs (e.g., | any of the sensing | |
| update | update | update rate; refreshing | related configurations | |
| | | rate; max detectable | | |
| | | speed; max detectable | | |
| | | range; max sensing | | |
| | | service latency; field of | | |
| | | view (FoV) and/or angle | | |
| | | of view (AoV); speed | | |
| | | resolution; range | | |
| | | resolution; angular | | |
| | | resolution; speed, range, | | |
| | | angular detection | | |
| | | accuracy; and/or the like. | | |
| | | 2. The sensing reference | | |
| | | signal configuration. | | |
| | | Note: From KPIs, | | |
| | | sensing reference signal | | |
| | | attributes is derived and | | |
| | | configured. The sensing | | |
| | | reference signal | | |
| | | configuration can be | | |
| | | separately listed. | | |
| | | 3. Sensing measurement | | |
| | | (or sensing data) | | |
| | | collection point | | |
| | | (processing stage). | | |
| Sensing | Sensing capability | Sensing precision, | Indicates change in | SSMF, AF |
| capability | | update rate, data | sensing capability of | |
| update | | processing stage | RAN | |
| Sensing QoS | Sensing service | Sensing | Indicates change of | SSMF, AF, |
| update | QoS | resolution/precision, | required sensing | RAN |
| | | update rate (or refreshing | service QoS | |
| | | rate), and/or other QoS | | |
| | | parameters | | |

Additionally or alternatively to the parameters defined in table 1.2.2-2, other parameters can be included as part of the event IDs. For example, the event IDs can include or indicate the NF(s) that detects each of the events, the purpose and/or use case(s) associated with each event, and/or possible actions that can be taken based on the event occurrence.

### 1.2.3. Example Sensing Data Collection and Delivery Procedures

### 1.2.3.1. Sensing Data Storage

The current DCCF/NWDAF framework does not specify where sensing data can and/or should be stored. Based on the network deployment, the NWDAF 862 and the ADRF 866 may be co-located or they may be separate NFs that communicate with one another via the Nadrf interface. An NFc (e.g., NWDAF 862 or DCCF 863) requests the ADRF 866 to store data or analytics (see e.g., FIG. 9, discussed infra).

In various embodiments, the sensing data and/or sensing data analytics can be stored in ADRF 866 or NWDAF 862. In some examples, the data storage location is a same location regardless of which NFc actually triggers the data collection/storage process.

In examples, different NFs (or NFcs) can trigger data collection, such as the RAN 804, NWDAF 862, SSMF 870, and/or some other NF/NFc. Additionally or alternatively, based on a sensing data analytics request from an NFc, an NF producer (NFp) of the sensing data analytics (e.g., RAN 804, NWDAF 862, SSMF 870, and/or some other NF) initiates data collection by directly subscribing to the NFp of the sensing data and/or via the DCCF 863. For example, if the NWDAF 862 is the NFp of the sensing data analytics, then based on the sensing data analytics request from the NFc, the NWDAF 862 initiates data collection either by directly subscribing to the NFp of the sensing data or via the DCCF 863. The sensing data collection by the SSMF 870 may be implementation-specific, or may be configured according to specific use case(s).

1.2.3.2. Sensing Data Storage in ADRF Directly without DCCF

FIG. 4 depicts an example procedure 400, where a RAN 804 requests an ADRF 866 to store sensing related data via the Nadrf interface. Here, the ADRF 866 can collect and store sensing data without the DCCF 863. In some implementations, the ADRF 866 can be co-located with the RAN 804 (e.g., where the ADRF 866 is a RAN function and/or the like). In other implementations, the ADRF 866 and the RAN 804 are separate entities and/or located at different (edge) cloud sites (e.g., where the ADRF 866 is deployed as an NF in a CN 840). When the ADRF 866 is an NF in the CN 840, the RAN 804 may connect to the ADRF 866 via an Nadrf interface.

In this example, the RAN 804 initiates the transfer/storage of sensing data at operation 401 by sending a data management storage request message to the ADRF 866 over the Nadrf interface (e.g., Nadrf_dataManagement_StoreRequest) to request storage of sensing data, or the RAN 804 sends a data management storage subscription message to the ADRF 866 over the Nadrf interface (e.g., Nadrf_dataManagement_StorageSubscriptionRequest) to subscribe to storing sensing data.

Either of these messages can include metadata related to the sensing data, such as the sensing service together with the event ID (see e.g., table 1.2.2-2, supra) if the storage event is triggered by an event. Additionally or alternatively, these messages can include metadata that describes the sensing data and/or the sensing job.

In some examples, the SSMF 870 instructs the RAN 804 about storing the sensing data and/or sensing data analytics, the relevant event ID(s), when to start and stop the storage of the sensing data and/or sensing data analytics, the purpose and/or use case(s) related to the sensing data and/or sensing data analytics, a validity period for the sensing data and/or sensing data analytics (e.g., whether the data is valid, fresh, or stale) for use when a consumer requests the data), whether the sensing data and/or sensing data analytics to be stored at the ADRF 866 is part of a sensing data collection for sensing service analytics, and/or other relevant information, data, and/or metadata.

At operation 402, the ADRF 866 sends a Nadrf_dataManagement_StoreResponse or Nadrf_dataManagemetn_StorageSubscriptionResponse to indicate whether the storage or the subscription of the sensing data was successful or not, and may include relevant cause values. Additionally or alternatively, the ADRF 866 stores the sensing data and/or sensing data analytics in the analytics database 867 (see e.g., FIG. 9) based on the request sent at operation 401.

FIG. 5 depicts an example sensing data collection configuration procedure 500, which may be performed by an SSMF 870. In this example, the SSMF 870 can set up sensing data collection (or a sensing data collection job) by the ADRF 866 as part of the sensing configuration procedure 500.

Procedure 500 begins at operation 501 where the SSMF 870 sends a sensing configuration request to the RAN 804 over the NS2 reference point (e.g., NS2_sensingConfiguration_Request). The NS2_sensingConfiguration_Request includes data collection instructions and/or configuration(s). Additionally or alternatively, the sensing configuration request includes, for example, instructions, configurations, and/or parameters related to how the sensing data is to be collected, purpose(s) and/or use case(s) related to the sensing data (e.g., sensing data is to be collected for a specific analytics ID and/or analytics report(s), where the specific analytics ID is sensing service analytics and/or the like), analytics ID (e.g., analytics for which data collected is requested or required), event ID(s), reporting threshold, data storage endpoint/target (e.g., ADRF 866), data collection target period (e.g., when to start and stop data collection), the sensing events the SSMF 870 is to subscribe to, and/or how the sensing data should be stored at the data storage endpoint/target.

In some examples, the SSMF 870 can instruct the RAN 804 to store the sensing data with one or more filters as described in table 1.2.2-2, whether the sensing data is to be stored directly to/at the ADRF 866 with an ADRF ID (e.g., internet protocol (IP) address, function ID, uniform resource identifier (URI), uniform resource location (URL), fully qualified domain name (FQDN), and/or some other network address or identifier, such as any of those discussed herein and/or in [TS38300]). Additionally or alternatively, the RAN 804 can indicate sensing data storage capabilities when registering the sensing capabilities to the SSMF 870.

At operation 502, the RAN 804 sends a sensing configuration response message to the SSMF 870 over the NS2 reference point (e.g., NS2_sensingConfiguration_response). The NS2_sensingConfiguration_response indicates the results of the configuration (e.g., whether the configuration was successful or not, and may include relevant cause values).

### 1.2.3.3. Sensing Data Collection by DCCF

FIG. 6 depicts an example procedure 600 for sensing data collection by a DCCF 863. In this example, the SSMF 870 can request sensing data collection through the DCCF 863, which will further request data collection at the RAN 804. In various implementations, multiple RANs 804 (or RAN nodes 814) and/or UEs 802 can be involved in procedure 600.

Procedure 600 begins at operation 601 where the SSMF 870 uses an NRF 854 to perform NF discovery and selection to find an appropriate DCCF 863 that can coordinate data collection. Here, the SSMF 870 sends a data management subscription/request for sensing data collection to DCCF 863 (e.g., Ndccf_DataManagement_Subscribe; see [TS23288]) with pre-processing and/or formatting requirements/parameters. The analytics consumer (e.g., SSMF 870) subscribes to analytics information via DCCF 863 by invoking the Ndccf_DataManagement_Subscribe service operation, which can include Nnwdaf service operation, analytics specification, formatting instructions, processing instructions, NWDAF (or NWDAF-Set) ID, ADRF information (e.g., ADRF endpoint address and/or ADRF ID), RAN information (e.g., RAN ID(s) and/or the like), and/or any other suitable information, such as any of the parameters indicated in [TS23288] § 6.1.3. The analytics consumer may specify one or more notification endpoints. The analytics consumer decides to go via DCCF 863 based on internal configuration. The analytics specification provides Nnwdaf service operation specific parameters (e.g., analytics IDs (see e.g., table 1.1.1-1, supra), target of analytics reporting and optional parameters used to retrieve the analytics, analytics filter information and/or sensing data filter, and/or the like). The analytics consumer may provide the identity of the NWDAF 862 to collect analytics from. The analytics consumer may provide additional information on possible notification endpoints or ADRF information so analytics are archived. In some examples, the RAN 802 is the data producer, and the SSMF 870 also provides a RAN ID, which is the data source for data collection. If the collected data is to be stored in the ADRF 866, the SSMF 870 also provides an ADRF endpoint ID to indicate the ADRF 866 where the RAN 804 is to store the sensing data (see e.g., FIG. 5). The SSMF 870 can also include one or more event IDs if the sensing data is related to a certain events (e.g., as defined in table 1.2.2-2). If an NWDAF 862 subscribes for data directly with a RAN 804, or the RAN 804 has stored data in the ADRF 866, the NWDAF 862 and/or ADRF 866 may register a data collection profile (e.g., including NWDAF ID and/or ADRF ID that specifics the NWDAF 862 and/or the ADRF 866 which registers the data collection profile) with the DCCF 863.

At operation 602, the DCCF 863 checks with the UDM 858 and/or the UDR 859 about whether the sensing data collection (or sensing measurement process/job) is allowed/permitted and/or if user consent is needed (e.g., if any UEs 802 is/are involved in the sensing measurement collection). Additionally or alternatively, if an NWDAF instance or NWDAF set is not identified by the analytics consumer, the DCCF 863 determines the NWDAF instance(s) 862 that can provide analytics. If the analytics consumer (e.g., SSMF 870) requested storage of analytics in an ADRF 866, but an ADRF ID is not provided by the analytics consumer, or the collected analytics is to be stored in an ADRF 866 according to configuration on the DCCF 863, the DCCF 863 selects an ADRF 866 to store the collected data. In some examples, operation 602 can be omitted from procedure 600.

At operation 603, the DCCF 863 checks whether the required/requested sensing data corresponding to the sensing analytics ID is already being collected (e.g., whether a sensing measurement job already exists for the sensing analytics ID). If the requested analytics are already being collected by an analytics consumer, the DCCF 863 adds the new analytics consumer (e.g., the SSMF 870) to the list of analytics consumers that are subscribed for these analytics (e.g., sensing service analytics). If the requested analytics are not already being collected by an analytics consumer, the DCCF 863 sends respective data subscription requests (e.g., Nns2_eventexposure_subscribe req) to the appropriate RAN(s) 804 with the requested sensing data filter as described in table 1.2.2-2 with the DCCF 863 indicated as a notification target (e.g., using a suitable DCCF ID/address) (e.g., operations 603a-1 to 603a-n, where n is a number). The RAN(s) 804 send respective data subscription responses (e.g., Nnf_eventexposure_notify resp) to indicate the results of the subscription request (e.g., operations 603b-1 to 603b-n). When the data is collected, the RAN(s) 804 can notify the DCCF 863 by sending, to the DCCF 863, respective event exposure notifications (e.g., Nnf_eventexposure_notify) including the sensing data (e.g., operations 603c-1 to 603c-n). In these message exchanges, the sensing data can be included with appropriate metadata (see e.g., table 1.2.2-1) to label the data. In some examples, when the sensing data is sent to the DCCF 863, the MFAF 865 can be leveraged for data delivery.

Additionally or alternatively, if the analytics requested at operation 601 are not already available or not being collected yet, the DCCF 863 subscribes to analytics from NWDAF 862 using the Nnwdaf_AnalyticsSubscription_Subscribe procedure as specified in [TS23288] § 6.1.1.1 (not shown by FIG. 6) and the DCCF 863 adds the analytics consumer to the list of analytics consumers that are subscribed for these analytics. If the analytics subscribed in operation 601 partially matches an analytics that is already being collected by the DCCF 863 from an NWDAF 862 and a modification of this subscription to the NWDAF 862 would satisfy both the existing analytics subscriptions as well as the newly requested analytics, the DCCF 863 invokes a modification of the previous subscription via Nnwdaf_AnalyticsSubscription_Subscribe service operation (as specified in [TS23288] § 6.1.1.1) and the DCCF 863 adds the analytics consumer (e.g., SSMF 870) to the list of analytics consumers that are subscribed for these analytics (e.g., sensing service analytics). Additionally, when new output analytics are available, the NWDAF 862 notifies the analytics information to the DCCF 863 by invoking the Nnwdaf_AnalyticsSubscription_Notify service operation (not shown by FIG. 6).

At operation 604, the DCCF 863 performs data processing and formatting based on the requirements sent by analytics consumer (e.g., SSMF 870) in the data management subscription request (see e.g., operation 601). Analytics sent to notification endpoints may be processed and formatted by the DCCF 863 (e.g., at operation 604) so they conform to delivery requirements for each analytics consumer or notification endpoint as specified in [TS23288] § 5A.4.

At operation 605, the DCCF 863 notifies the SSMF 870 and any additional notification end point(s) indicated in the data management subscription request that data is ready, and sends a suitable data notification directly to SSMF 870 with appropriate metadata. Additionally or alternatively, the DCCF 863 uses Ndccf_DataManagement_Notify service to send the analytics (e.g., sensing service analytics obtained from the NWDAF 862 and/or the RAN(s) 804) to all notification endpoints indicated in operation 601 (e.g., the SSMF 870). Additionally or alternatively, the DCCF 863 may store the analytics in the ADRF 866 if requested by the analytics consumer (e.g., SSMF 870) or if required by DCCF configuration, using procedure as specified in [TS23288] § 6.2B.3.

At operation 606, the SSMF 870 fetches analytics data (e.g., sensing service analytics) by signaling the DCCF 863 using suitable message(s) and/or service operations. For example, if a Ndccf_DataManagement_Notify contains a fetch instruction, the notification endpoint (e.g., SSMF 870) sends a Ndccf_DataManagement_Fetch request to fetch the analytics from the DCCF 863 before an expiry time, and the DCCF 863 delivers the analytics to the notification endpoint (e.g., SSMF 870) in a Ndccf_DataManagement_Fetch response.

Additionally or alternatively, the analytics consumer/notification endpoint (e.g., SSMF 870) obtains the analytics data (e.g., sensing service analytics) by/through the MFAF 865, wherein the notification endpoint (e.g., SSMF 870) sends a Nmfaf_3caDataManagement_Fetch request to fetch the analytics from the MFAF 865 before an expiry time, and the MFAF 865 delivers the analytics to the notification endpoint (e.g., SSMF 870) in a Nmfaf_3caDataManagement_Fetch response (not shown by FIG. 6). In some examples, operation 606 can be omitted from procedure 600.

At operation 607, the SSMF 870 sends an unsubscribe request (e.g., Ndccf_dataManagement_unsubscribe) message to the DCCF 863 to stop the data collection process. When the analytics consumer (e.g., SSMF 870) no longer wants analytics to be collected it invokes Ndccf_DataManagement_Unsubscribe using the subscription correlation ID received in response to its subscription in operation 601. Based on this message, the DCCF 863 removes the analytics consumer from the list of analytics consumers that are subscribed for these analytics. In some examples. If there are no other analytics consumers subscribed to the analytics, the DCCF 863 unsubscribes with the NWDAF 862 (not shown by FIG. 6).

### 1.2.3.4. NWDAF Based Sensing Data Collection

In some implementations, the NWDAF 862 can request sensing data through the AMF 844 via the N2 reference point and/or over the Namf (or Nran) SBI exposed by AMF 844 and/or the RAN 804 for data management. Additionally or alternatively, the NWDAF 862 can subscribe to be notified for data on a set of events using the Namf_EventExposure service as described by [TS23502] §§ 5.2.2.3, 5.2.3.5. Additionally or alternatively, NWDAF sensing data can be collected from various NFs based on the services of exposed/provided by the NFs (e.g., AMF 844, SMF 846, UDM 858, PCF 856, NRF 854, NSACF, AF 860, and/or NEF 852), wherein the event exposure services offered by each NF is discussed in clauses 4.15 and 5.2 of [TS23502].

1.2.3.5. Sensing Analytics Retrieval from NWDAF

FIG. 7 depicts an example procedure 700 for sensing data analytics retrieval from NWDAF 862 via DCCF 863. In this example, the SSMF 870 can request sensing data analytics from the NWDAF 862, which can collect sensing data through the DCCF 863 and/or the ADRF 866 as a background process. The NWDAF 862 can also register the supported analytics with the DCCF 863 and/or the NRF 854 as part of the NF profile for the SSMF 870 to find the appropriate NWDAF 862 instance based on sensing data filters.

Procedure 700 begins at operation 701 where the SSMF 870 discovers and selects an NWDAF instance via the NRF 854 based on the analytics ID, supported services, NWDAF capabilities, NWDAF serving area information, and/or other information, such as any of the information/data discussed herein.

At operation 702, the NWDAF service consumer (e.g., SSMF 870) sends an analytics subscribe message (e.g., Nnwdaf_AnalyticsSubscription_Subscribe) to the selected NWDAF instance 862. Here, the NWDAF service consumer (e.g., SSMF 870) subscribes to analytics information by invoking the Nnwdaf_AnalyticsSubscription_Subscribe service operation.

Alternatively, at operation 702′, the NWDAF service consumer (e.g., SSMF 870) sends an analytics request message (e.g., Nnwdaf_AnalyticsSubscription_Subscribe) to the selected NWDAF instance 862. Here, the NWDAF service consumer (e.g., SSMF 870) requests analytics information by invoking an Nnwdaf_AnalyticsInfo_Request service operation.

The analytics request/subscribe message at operation 702 and 702′ includes various criteria of the sensing data and/or analytics based on the sensing data, analytics ID, event ID, some or all of the parameters defined in table 1.2.2-2, target of analytics reporting, analytics filter information, reporting endpoint (e.g., AF 860), serving area information and/or sensing coverage area, and/or other suitable information/data, such as any of the parameters listed in [TS23288] § 6.1.3.

At operation 703, if a DCCF 863 is used for data collection and coordination in the network, the NWDAF 862 selects a DCCF instance 863 based on the DCCF 863 serving area information and/or sensing coverage area, and/or other relevant data/information, such as some or all of the information obtained in the analytics request/subscribe message. Additionally or alternatively, when a subscription to analytics information or a request for analytics information is received, the NWDAF 862 determines whether triggering new data collection is needed

At operation 704, the NWDAF 862 sends a data management subscription request message (e.g., Ndccf_dataManagement_Subscribe/Request) to the DCCF 863. The data management subscription request message includes required/desired pre-processing and/or formatting rules/requirements. Additionally or alternatively, this message includes the sensing analytics ID, sensing data filter, [ADRF endpoint], [RAN identifier], [notification endpoint(s)], and/or other relevant information/data. W.r.t the notification endpoint(s), the SSMF 870 can request the DCCF 863 to send the sensing data and/or analytics to one or more notification endpoints by including the appropriate endpoint IDs/address in this message.

At operation 705, the DCCF 863 notifies the NWDAF 862 and any additional notification end point(s) included in the data management subscription request message via a data management notification message (e.g., Ndccf_dataManagement_Notification/Response) with the requested sensing data and/or analytics.

At operation 706, the NWDAF 862 derives or otherwise generates the requested sensing service analytics based on the data received from the DCCF 863. In some examples, the NWDAF 862 performs the various (pre-) processing operations and/or applies various rules and/or logic to derive or otherwise generate the sensing service analytics. Additionally or alternatively, the NWDAF 862 can use one or more suitable AI/ML models to derive or otherwise generate the sensing service analytics.

At operation 707, the NWDAF 862 sends an analytics subscription notification or response message (e.g., Nnwdaf_AnalyticsSubscription_Notify) to the NWDAF service consumer (e.g., SSMF 870) with the requested sensing data analytics. If NWDAF service consumer is subscribed to analytics information, the NWDAF 862 notifies the NWDAF service consumer (e.g., SSMF 870) with the analytics information by invoking an Nnwdaf_AnalyticsSubscription_Notify service operation, based on the request from the NWDAF service consumer (e.g., analytics reporting parameters). Alternatively, at operation 707′, the NWDAF 862 responds with analytics information (e.g., including the generated sensing service analytics) to the NWDAF service consumer (e.g., SSMF 870).

In some implementations, the SSMF 870 sends a request to the DCCF 863 with the criteria of the sensing data and/or analytics based on the sensing data analytics ID, event ID and the parameters defined in table 1.2.2-2. Based on this trigger, the DCCF 863 subscribes with the NWDAF 862 to receive sensing service analytics.

Additionally or alternatively to the procedure of FIG. 7, the sensing data analytics can be retrieved from the NWDAF 862 according to the procedures discussed in clause 6.1 of [TS23288], where the SSMF 870 is the NWDAF service consumer and/or the analytics consumer.

### 2. Network, System, and Device Configurations and Arrangements

FIG. 8 depicts an example network architecture 800. The network 800 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 800 includes a UE 802, which is any mobile or non-mobile computing device designed to communicate with a RAN 804 via an over-the-air connection. The UE 802 is communicatively coupled with the RAN 804 by a Uu interface, which may be applicable to both LTE and NR systems. Examples of the UE 802 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. The UE 802 may be the same or similar to any of the other UEs discussed herein such as, for example, UE 1002, hardware resources 1100, and/or any other UE discussed herein.

The network 800 includes a set of UEs 802, some of which may be coupled directly with one another via a device-to-device (D2D), proximity services (ProSe), PC5, and/or sidelink (SL) interface, and/or any other suitable interface such as any of those discussed herein. These UEs 802 may be M2M, D2D, MTC, and/or IoT devices, and/or V2X systems that communicate using physical SL channels such as, but not limited to, PSBCH, PSDCH, PSSCH, PSCCH, PSFCH, and the like. The UE 802 may perform blind decoding attempts of SL channels/links according to the various examples herein.

In some examples, the UE 802 may additionally communicate with an AP 806 via an over-the-air (OTA) connection. The AP 806 manages a WLAN connection, which may serve to offload some/all network traffic from the RAN 804. The connection between the UE 802 and the AP 806 may be consistent with any IEEE 802.11 protocol. Additionally, the UE 802, RAN 804, and AP 806 may utilize cellular-WLAN aggregation/integration (e.g., LWA/LWIP). Cellular-WLAN aggregation may involve the UE 802 being configured by the RAN 804 to utilize both cellular radio resources and WLAN resources.

The RAN 804 includes one or more network access nodes (NANs) 814 (also referred to as “RAN nodes 814”). The NANs 814 terminate air-interface(s) for the UE 802 by providing access stratum protocols including RRC, PDCP, RLC, MAC, and PHY/L1 protocols. In this manner, the NAN 814 enables data/voice connectivity between a core network (CN) 840 and the UE 802. The NANs 814 may be a macrocell base station or a low power base station for providing femtocells, picocells or other like cells having smaller coverage areas, smaller user capacity, or higher bandwidth compared to macrocells; or some combination thereof. In these implementations, a NAN 814 may be referred to as a base station (BS), next generation nodeB (gNB), RAN node, eNodeB (eNB), next generation (ng)-eNB, NodeB, RSU, TRP, and/or the like.

One example implementation is a “CU/DU split” architecture where the NANs 814 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The NANs 814 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of NANs 814 are coupled with one another via respective Xn interfaces if the RAN 804 is a NG-RAN 804. The X2/Xn interfaces, which may be separated into control/user plane interfaces in some examples, may allow the ANs to communicate information related to handovers, data/context transfers, mobility, load management, interference coordination, and the like.

The ANs of the RAN 804 may each manage one or more cells, cell groups, component carriers, and the like to provide the UE 802 with an air interface for network access. The UE 802 may be simultaneously connected with a set of cells provided by the same or different NANs 814 of the RAN 804. For example, the UE 802 and RAN 804 may use carrier aggregation to allow the UE 802 to connect with a set of component carriers, each corresponding to a PCell or SCell. In dual connectivity scenarios, a first NAN 814 may be a master node that provides an MCG and a second NAN 814 may be secondary node that provides an SCG. The first/second NANs 814 may be any combination of eNB, gNB, ng-eNB, and the like.

The RAN 804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 802 provide radio information to one or more NANs 814 and/or one or more edge compute nodes (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 802 current location). As examples, the measurements collected by the UEs 802 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N0), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP 806 or RAN node 814 reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP. RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Additional or alternative measurements can be additionally or alternatively used, such as any of those discussed in 3GPP TS 36.214, 3GPP TS 38.215 (“[TS38215]”), 3GPP TS 38.314, 3GPP TS 32.422, 3GPP TS 28.552 (“[TS28552]”), 3GPP TS 32.425 (“[TS32425]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by one or more NANs 814 and provided to the edge compute node(s).

The measurements/metrics may be collected and/or reported in response to a trigger event and/or on a periodic basis. Additionally or alternatively, individual UEs 802 and/or NANs 814 collect and report measurements/metrics either at a low periodicity or a high periodicity depending on a data transfer that is to take place, and/or other information about the data transfer. Additionally or alternatively, the edge compute node(s) may request the measurements from the NANs 814 at low or high periodicity, or the NANs 814 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 802 such as Key Performance Indicators (KPIs), with the measurement reports or separately from the measurement reports.

Additionally or alternatively, in cases where is discrepancy in the observation data from one or more UEs 802, one or more RAN nodes 814, and/or NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

The UE 802 can also perform determine reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 802 can include those discussed in 3GPP TS 38.211, 3GPP TS 38.212, 3GPP TS 38.213, 3GPP TS 38.214, [TS38215], 3GPP TS 38.101-1, 3GPP TS 38.104, 3GPP TS 38.133, [TS38331], 3GPP TS 32.422, [TS28622], [TS28532], and/or other standards/specifications, including any of those mentioned herein. The physical signals and/or reference signals can include demodulation reference signals (DMRS), phase-tracking reference signals (PTRS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a hardware (HW) configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP, ETSI, O-RAN, IETF, IEEE, and/or any other like standards such as those discussed herein.

In some examples, the RAN 804 is an E-UTRAN with one or more eNBs, and provides an LTE air interface (Uu) with the parameters and characteristics at least as discussed in 3GPP TS 36.300. In some examples, the RAN 804 is an next generation (NG)-RAN 804 with a set of RAN nodes 814 (including gNBs 814a and ng-eNBs 814b). Each gNB 814a connects with 5G-enabled UEs 802 using a 5G-NR Uu interface with parameters and characteristics as discussed in [TS38300], among many other 3GPP standards, including any of those discussed herein. Where the NG-RAN 804 includes a set of ng-eNBs 814b, the one or more ng-eNBs 814b connect with a UE 802 via the 5G Uu and/or LTE Uu interface. The gNBs 814a and the ng-eNBs 814b connect with the 5GC 840 through respective NG interfaces, which include an N2 interface, an N3 interface, and/or other interfaces. The gNBs 814a and the ng-eNBs 814b are connected with each other over an Xn interface. Additionally, individual gNBs 814a are connected to one another via respective Xn interfaces, and individual ng-eNBs 814b are connected to one another via respective Xn interfaces. In some examples, the NG interface may be split into two parts, an NG user plane (NG-U) interface, which carries traffic data between the nodes of the NG-RAN 804 and a UPF 848 (e.g., N3 interface), and an NG control plane (NG-C) interface, which is a signaling interface between the nodes of the NG-RAN 804 and an AMF 844 (e.g., N2 interface).

The NG-RAN 804 provides a 5G-NR air interface (which may also be referred to as a Uu interface) with the following characteristics: variable subcarrier spacing (SCS); cyclic prefix (CP)-OFDM for downlink (DL), CP-OFDM and Discrete Fourier Transform (DFT)-Spread(s)-s-OFDM for uplink (UL); polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on frequency rang 1 (FR1) bands that include sub-6 GHz bands or frequency rang 2 (FR2) bands that include bands from 24.25 GHZ to 52.6 GHz. The 5G-NR air interface may include an SSB that is an area of a DL resource grid that includes PSS/SSS/PBCH.

The 5G-NR air interface may utilize BWPs for various purposes. For example, BWP can be used for dynamic adaptation of the SCS. For example, the UE 802 can be configured with multiple BWPs where each BWP configuration has a different SCS. When a BWP change is indicated to the UE 802, the SCS of the transmission is changed as well. Another use case example of BWP is related to power saving. In particular, multiple BWPs can be configured for the UE 802 with different amount of frequency resources (e.g., PRBs) to support data transmission under different traffic loading scenarios. A BWP containing a smaller number of PRBs can be used for data transmission with small traffic load while allowing power saving at the UE 802 and in some cases at the gNB 814a. A BWP containing a larger number of PRBs can be used for scenarios with higher traffic load.

In some implementations, individual gNBs 814a can include a gNB-CU and a set of gNB-DUs. Additionally or alternatively, gNBs 814a can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U. Similarly, individual ng-eNBs 814b can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re) activation to the node having control plane connection towards the core network (e.g., over E1. X2, or the like). The node hosting the RLC protocol layer (e.g., gNB-DU) may perform user inactivity monitoring and further inform its inactivity or (re) activation to the node hosting the control plane (e.g., gNB-CU or gNB-CU-CP).

In these implementations, the NG-RAN 804, is layered into a Radio Network Layer (RNL) and a Transport Network Layer (TNL). The NG-RAN 804 architecture (e.g., the NG-RAN logical nodes and interfaces between them) is part of the RNL. For each NG-RAN interface (e.g., NG, Xn. F1, and the like) the related TNL protocol and the functionality are specified. The TNL provides services for user plane transport and/or signaling transport. In NG-Flex configurations, each NG-RAN node is connected to all AMFs 844 of AMF sets within an AMF region supporting at least one slice also supported by the NG-RAN node. The AMF Set and the AMF Region are defined in [TS23501].

The RAN 804 is communicatively coupled to CN 840 that includes network elements and/or network functions (NFs) to provide various functions to support data and telecommunications services to customers/subscribers (e.g., UE 802). The components of the CN 840 may be implemented in one physical node or separate physical nodes. In some examples, NFV may be utilized to virtualize any or all of the functions provided by the network elements of the CN 840 onto physical compute/storage resources in servers, switches, and the like. A logical instantiation of the CN 840 may be referred to as a network slice, and a logical instantiation of a portion of the CN 840 may be referred to as a network sub-slice.

In the example of FIG. 8, the CN 840 is a 5GC 840 including an Authentication Server Function (AUSF) 842, Access and Mobility Management Function (AMF) 844, Session Management Function (SMF) 846, User Plane Function (UPF) 848, Network Slice Selection Function (NSSF) 850, Network Exposure Function (NEF) 852, Network Repository Function (NRF) 854, Policy Control Function (PCF) 856, Unified Data Management (UDM) 858, Unified Data Repository (UDR) 859, Application Function (AF) 860, and Network Data Analytics Function (NWDAF) 862 coupled with one another over various interfaces as shown. The NFs in the 5GC 840 are briefly introduced as follows.

The NWDAF 862 is an NF capable of collecting data from UEs 802, other NF(s) in 5GC 840 (e.g., AMF 844, SMF 846, UPF 848, PCF 856, UDM 858, Network Slice Admission Control Function (NSACF), AF 860 (directly and/or via the NEF 852)), Operations, Administration and Maintenance (OAM) entities/functions, external AFs 860, DNs 836, server(s) 838, cloud computing services, edge compute nodes and/or edge networks, and/or other entities/elements that can be used for analytics.

The NWDAF 862 includes one or more of the following functionalities: support data collection from NFs and AFs 860; support data collection from OAM; NWDAF service registration and metadata exposure to NFs and AFs 860; support analytics information provisioning to NFs and AFs 860; support ML model training and provisioning to NWDAF(s) 862 (e.g., those containing analytics logical function). Some or all of the NWDAF functionalities can be supported in a single instance of an NWDAF 862. The NWDAF 862 also includes an analytics reporting capability, which comprises means that allow discovery of the type of analytics that can be consumed by an external party and/or the request for consumption of analytics information generated by the NWDAF 862. The NWDAF 862 can collect data from NF(s) and/or other entities/elements/functions over an Nnf service-based interface associated with the NF(s) and/or other entities/elements/functions. The NWDAF 862 belongs to the same PLMN as the NF that provides the data. The Nnf interface is defined for the NWDAF 862 to request subscription to data delivery for a particular context, cancel subscription to data delivery, and request a specific report of data for a particular context. The 5GS architecture also allows the NWDAF 862 to retrieve management data from an OAM entity by invoking OAM services.

The NWDAF 862 interacts with different entities for different purposes, such as one or more of the following: data collection based on subscription to events provided by AMF 844, SMF 846, PCF 856. UDM 858, NSACF, AF 860 (directly or via NEF 852) and OAM; analytics and data collection using the DCCF 863; retrieval of information from data repositories (e.g., UDR 859 via UDM 858 for subscriber-related information); data collection of location information from LCS system; storage and retrieval of information from ADRF 866; analytics and data collection from MFAF 865; retrieval of information about NFs (e.g., from NRF 854 for NF-related information); on-demand provision of analytics to consumers, as specified in clause 6 of [TS23288]; provision of bulked data related to analytics ID(s); provision of accuracy information about analytics ID(s); and/or provision of ML model accuracy information and/or ML model accuracy degradation about one or more ML models. NWDAF discovery and selection procedures are discussed in clause 6.3.13 in [TS23501] and clause 5.2 of [TS23288].

A single instance or multiple instances of NWDAF 862 may be deployed in a PLMN. If multiple NWDAF 862 instances are deployed, the architecture supports deploying the NWDAF 862 as a central NF, as a collection of distributed NFs, or as a combination of both. If multiple NWDAF 862 instances are deployed, an NWDAF 862 can act as an aggregate point (e.g., aggregator NWDAF 862) and collect analytics information from other NWDAFs 862, which may have different serving areas, to produce the aggregated analytics (e.g., per analytics ID), possibly with analytics generated by itself. When multiple NWDAFs 862 exist, not all of them need to be able to provide the same type of analytics results. For example, some of the NWDAFs 862 can be specialized in providing certain types of analytics.

An analytics ID information element (IE) is used to identify the type of supported analytics that NWDAF 862 can generate. In some implementations, NWDAF instance(s) 862 can be collocated with another 5GS NF.

Different NWDAF instances 862 may be present in the 5GC 840, with possible specializations per type of analytics (and/or per analytics ID). The capabilities of an NWDAF instance 862 are described in the NWDAF profile stored in the NRF 854, which is described in more detail infra. In a multiple NWDAF deployment scenario, an NWDAF instance 862 may be specialized to provide analytics for one or more analytics IDs. Each of the NWDAF instances 862 may serve a certain area of interest, one or more tracking area identities (TAI(s)), service area(s), registration area(s), DN name(s) (DNN(s)), local DNN(s), DN access ID(s) (DNAI(s)), and/or some other predefined or configured region/area, service, application, or other entity/element. Multiple NWDAFs 862 may collectively serve the particular analytics ID(s). An NWDAF 862 may have the capability to support the aggregation of analytics (e.g., per analytics ID) received from other NWDAFs 862, possibly with analytics generated by itself.

The NWDAF 862 may contain an analytics logical function (AnLF) 862a and/or a model training logical function (MTLF) 862b (see e.g., FIG. 9). The NWDAF 862 can contain only an MTLF 862b, only an AnLF 862a, or both logical functions. The 5GS architecture allows an NWDAF containing an AnLF 862a (referred to herein as “NWDAF-ANLF AnLF 862a” and/or the like) to use trained ML model provisioning services from the same or different NWDAF containing an MTLF 862b (also referred to herein as “NWDAF-MTLF 862b”). The Nnwdaf interface is used by the NWDAF-AnLF 862a to request and subscribe to trained ML model provisioning services provided by the NWDAF-MTLF 862b. The NWDAF 862 provides an Nnwdaf_MLModelProvision service enables an NF service consumer (NFc) to receive a notification when an ML model matching the subscription parameters becomes available in the NWDAF-MTLF 862b (see e.g., clause 7.5 of [TS23288]). The NWDAF 862 provides an Nnwdaf_MLModelInfo service that enables an NFc to request and get ML Model information from the NWDAF-MTLF 862b (see e.g., clause 7.6 of [TS23288]).

The AnLF 862a is a logical function in the NWDAF 862 that performs inference, derives analytics information (e.g., derives statistics, inferences, and/or predictions based on analytics consumer requests) and exposes analytics services (e.g., Nnwdaf_AnalyticsSubscription or Nnwdaf_AnalyticsInfo). Analytics information are either statistical information of the past events, or predictive information (e.g., generating predictions/inferences using one or more AI/ML models and/or the like). The MTLF 862b is a logical function in the NWDAF 862 that trains AI/ML models and exposes new training services (e.g., providing trained ML model) as defined in clauses 7.5 and 7.6 of [TS23288].

To guarantee the accuracy of analytics output for an analytics ID, based on the UE abnormal behavior analytics from itself and/or other NWDAFs 862 including abnormal UE list and the observed time window, the NWDAF 862 is to detect and may delete the input data from the abnormal UE(s) 802 and then may generate a new ML model and/or analytics outputs for the analytics ID without the input data related to abnormal UE list during the observed time window and then send/update the ML model information and/or analytics outputs to the subscribed NWDAF service consumer.

In order to support NFs to discover and select an NWDAF-MTLF 862b, NWDAF-AnLF 862a, or both, that is able to provide the required service (e.g., analytics exposure, ML model provisioning, sensing services, and/or the like) for the required type of analytics, each NWDAF instance 862 should provide the list of supported analytics ID(s), possibly per supported service (e.g., sensing services including any of those discussed herein), when registering to the NRF 854, in addition to other NRF registration elements of the NF profile. NFs requiring the discovery of an NWDAF instance 862 that provides support for some specific service(s) (e.g., sensing services and/or the like) for a specific type of analytics may query the NRF 854 for NWDAFs 862 supporting the required service(s) (e.g., sensing services and/or the like) and the required analytics ID(s).

Since multiple NWDAF 862 instances may be deployed in a network, an NFc can utilize the NRF 854 to discover NWDAF 862 instance(s) unless NWDAF information is available by other means (e.g., locally configured on NFcs). NFcs may make an additional query to the UDM 858, when supported. An NWDAF selection function in an NFc selects an NWDAF instance 862 (or an NWDAF-MTLF instance 862b and/or NWDAF-AnLF instance 862a) based on the available NWDAF 862 instances, a list of supported analytics ID(s) (e.g., possibly per supported service) stored/from an NRF 854, NWDAF capabilities (e.g., analytics aggregation capability, analytics metadata provisioning capability. ML model training capabilities, ML model deployment capabilities, and/or the like), and/or other NRF 854 registration elements of the NF profile. Additional aspects of NWDAF 862 functionality are defined in 3GPP TS 23.288 (“[TS23288]”).

The AUSF 842 stores data for authentication of UE 802 and handle authentication-related functionality. The AUSF 842 may facilitate a common authentication framework for various access types.

The AMF 844 allows other functions of the 5GC 840 to communicate with the UE 802 and the RAN 804 and to subscribe to notifications about mobility events w.r.t the UE 802. The AMF 844 is also responsible for registration management (e.g., for registering UE 802), connection management, reachability management, mobility management, lawful interception of AMF-related events, and access authentication and authorization. The AMF 844 provides transport for SM messages between the UE 802 and the SMF 846, and acts as a transparent proxy for routing SM messages. AMF 844 also provides transport for SMS messages between UE 802 and an SMSF. AMF 844 interacts with the AUSF 842 and the UE 802 to perform various security anchor and context management functions. Furthermore, AMF 844 is a termination point of a RAN-CP interface, which includes the N2 reference point between the RAN 804 and the AMF 844. The AMF 844 is also a termination point of non-access stratum (NAS) (N1) signaling, and performs NAS ciphering and integrity protection.

The AMF 844 also supports NAS signaling with the UE 802 over an N3IWF interface.

The N3IWF provides access to untrusted entities. N3IWF may be a termination point for the N2 interface between the (R)AN 804 and the AMF 844 for the control plane, and may be a termination point for the N3 reference point between the (R)AN 804 and the 848 for the user plane. As such, the AMF 844 handles N2 signaling from the SMF 846 and the AMF 844 for PDU sessions and

QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 802 and AMF 844 via an N1 reference point between the UE 802 and the AMF 844, and relay UL and DL user-plane packets between the UE 802 and UPF 848. The N3IWF also provides mechanisms for IPsec tunnel establishment with the UE 802. The AMF 844 may exhibit an Namf service-based interface, and may be a termination point for an N14 reference point between two AMFs 844 and an N17 reference point between the AMF 844 and a 5G-EIR (not shown by FIG. 8). In addition to the functionality of the AMF 844 described herein, the AMF 844 may provide support for Network Slice restriction and Network Slice instance restriction based on NWDAF analytics.

The SMF yx46 is responsible for SM (e.g., session establishment, tunnel management between UPF 848 and NAN 814); UE IP address allocation and management (including optional authorization); selection and control of UP function; configuring traffic steering at UPF 848 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 844 over N2 to NAN 814; and determining SSC mode of a session. SM refers to management of a PDU session, and a PDU session or “session” refers to a PDU connectivity service that provides or enables the exchange of PDUs between the UE 802 and the DN 836. The SMF 846 may also include the following functionalities to support edge computing enhancements (see e.g., [TS23548]): selection of EASDF 861 and provision of its address to the UE as the DNS server for the PDU session; usage of EASDF 861 services as defined in [TS23548]; and for supporting the application layer architecture defined in [TS23558], provision and updates of ECS address configuration information to the UE. Discovery and selection procedures for EASDFs 861 is discussed in [TS23501] § 6.3.23.

The UPF 848 acts as an anchor point for intra-RAT and inter-RAT mobility, an external PDU session point of interconnect to data network 836, and a branching point to support multi-homed PDU session. The UPF 848 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 848 may include an UL classifier to support routing traffic flows to a data network.

The NSSF 850 selects a set of network slice instances serving the UE 802. The NSSF 850 also determines allowed NSSAI and the mapping to the subscribed S-NSSAIs, if needed. The NSSF 850 also determines an AMF set to be used to serve the UE 802, or a list of candidate AMFs 844 based on a suitable configuration and possibly by querying the NRF 854. The selection of a set of network slice instances for the UE 802 may be triggered by the AMF 844 with which the UE 802 is registered by interacting with the NSSF 850; this may lead to a change of AMF 844.

The NSSF 850 interacts with the AMF 844 via an N22 reference point; and may communicate with another NSSF in a visited network via an N31 reference point (not shown).

The NEF 852 securely exposes services and capabilities provided by 3GPP NFs for third party, internal exposure/re-exposure, AFs 860, edge computing networks/frameworks, and the like. In such examples, the NEF 852 may authenticate, authorize, or throttle the AFs 860. The NEF 852 stores/retrieves information as structured data using the Nudr interface to a UDR 859. The NEF 852 also translates information exchanged with the AF 860 and information exchanged with internal NFs. For example, the NEF 852 may translate between an AF-Service-Identifier and an internal 5GC information, such as DNN, S-NSSAI, as described in clause 5.6.7 of [TS23501]. In particular, the NEF 852 handles masking of network and user sensitive information to external AF's 860 according to the network policy. The NEF 852 also receives information from other NFs based on exposed capabilities of other NFs. This information may be stored at the NEF 852 as structured data, or at a data storage NF using standardized interfaces. The stored information can then be re-exposed by the NEF 852 to other NFs and AFs, or used for other purposes such as analytics. For example, NWDAF analytics may be securely exposed by the NEF 852 for external party, as specified in [TS23288]. Furthermore, data provided by an external party may be collected by the NWDAF 862 via the NEF 852 for analytics generation purpose. The NEF 852 handles and forwards requests and notifications between the NWDAF 862 and AF(s) 860, as specified in [TS23288].

The NRF 854 supports service discovery functions, receives NF discovery requests from NF instances, and provides information of the discovered NF instances to the requesting NF instances. The NRF 854 also maintains NF profiles of available NF instances and their supported services. The NF profile of NF instance maintained in the NRF 854 includes the following information: NF instance ID; NF type; PLMN ID in the case of PLMN, PLMN ID+NID in the case of SNPN; Network Slice related Identifier(s) (e.g., S-NSSAI, NSI ID); an NF's network address(es) (e.g., FQDN, IP address, and/or the like), NF capacity information, NF priority information (e.g., for AMF selection), NF set ID, NF service set ID of the NF service instance; NF specific service authorization information; names of supported services, if applicable; endpoint address(es) of instance(s) of each supported service; identification of stored data/information (e.g., for UDR profile and/or other NF profiles); other service parameter(s) (e.g., DNN or DNN list, LADN DNN or LADN DNN list, notification endpoint for each type of notification that the NF service is interested in receiving, and/or the like); location information for the NF instance (e.g., geographical location, data center, and/or the like); TAI(s); NF load information; Routing Indicator, Home Network Public Key identifier, for UDM 858 and AUSF 842; for UDM 858, AUSF 842, and NSSAAF in the case of access to an SNPN using credentials owned by a Credentials Holder with AAA Server, identification of Credentials Holder (e.g., the realm of the Network Specific Identifier based SUPI); for UDM 858 and AUSF 842, and if UDM 858/AUSF 842 is used for access to an SNPN using credentials owned by a Credentials Holder, identification of Credentials Holder (e.g., the realm if network specific identifier based SUPI is used or the MCC and MNC if IMSI based SUPI is used); for AUSF 842 and NSSAAF in the case of SNPN Onboarding using a DCS with AAA server, identification of DCS (e.g., the realm of the Network Specific Identifier based SUPI); for UDM 858 and AUSF 842, and if UDM 858/AUSF 842 is used as DCS in the case of SNPN Onboarding, identification of DCS ((e.g., the realm if Network Specific Identifier based SUPI, or the MCC and MNC if IMSI based SUPI); one or more GUAMI(s), in the case of AMF 844; for the UPF 848, see [TS23502] § 5.2.7.2.2; UDM Group ID, range(s) of SUPIs, range(s) of GPSIs, range(s) of internal group identifiers, range(s) of external group identifiers for UDM 858; UDR Group ID, range(s) of SUPIs, range(s) of GPSIs, range(s) of external group identifiers for UDR; AUSF Group ID, range(s) of SUPIs for AUSF 842; PCF Group ID, range(s) of SUPIs for PCF 856; HSS Group ID, set(s) of IMPIs, set(s) of IMPU, set(s) of IMSIs, set(s) of PSIs, set(s) of MSISDN for HSS; event ID(s) supported by AFs 860, in the case of NEF 852; event Exposure service supported event ID(s) by UPF 848; application identifier(s) supported by AFs 860, in the case of NEF 852; range(s) of external identifiers, or range(s) of external group identifiers, or the domain names served by the NEF 852, in the case of NEF 852 (e.g., used when the NEF 852 exposes AF information for analytics purpose as detailed in [TS23288]; additionally the NRF 854 may store a mapping between UDM Group ID and SUPI(s), UDR Group ID and SUPI(s), AUSF Group ID and SUPI(s) and PCF Group ID and SUPI(s), to enable discovery of UDM 858, UDR 859, AUSF 842 and PCF 856 using SUPI, SUPI ranges as specified in [TS23501] § 6.3, and/or interact with UDR 859 to resolve the UDM Group ID/UDR Group ID/AUSF Group ID/PCF Group ID based on UE identity (e.g., SUPI)); IP domain list as described in clause 6.1.6.2.21 of 3GPP TS 29.510, Range(s) of (UE) IPv4 addresses or Range(s) of (UE) IPv6 prefixes. Range(s) of SUPIs or Range(s) of GPSIs or a BSF Group ID, in the case of BSF; SCP Domain the NF belongs to; DCCF Serving Area information. NF types of the data sources. NF Set IDs of the data sources, if available, in the case of DCCF; supported DNAI list, in the case of SMF 846; for SNPN, capability to support SNPN Onboarding in the case of AMF and capability to support User Plane Remote Provisioning in the case of SMF 846; IP address range. DNAI for UPF 848; additional V2X related NF profile parameters are defined in 3GPP TS 23.287; additional ProSe related NF profile parameters are defined in 3GPP TS 23.304; additional MBS related NF profile parameters are defined in 3GPP TS 23.247; additional UAS related NF profile parameters are defined in 3GPP TS 23.256; among many others discussed in [TS23501]. In some examples, service authorization information provided by an OAM system is also included in the NF profile in the case that, for example, an NF instance has an exceptional service authorization information.

For NWDAF 862, the NF profile includes: list or set of supported analytics ID(s) (possibly per service), NWDAF serving area information (e.g., a list of TAIs for which the NWDAF can provide services and/or data), supported analytics delay per analytics ID (if available), NF types of the NF data sources, NF set IDs of the NF data sources (if available), analytics aggregation capability (if available), analytics metadata provisioning capability (if available), ML model filter information parameters S-NSSAI(s) and area(s) of interest for the trained ML model(s) per analytics ID(s) (if available), federated learning (FL) capability type (e.g., FL server or FL client, if available), Time interval supporting FL (if available). The NWDAF's 862 Serving Arca information is common to all its supported analytics IDs. The analytics IDs supported by the NWDAF 862 may be associated with a supported analytics delay, for example, the analytics report can be generated with a time (including data collection delay and inference delay) in less than or equal to the supported analytics delay. The determination of supported analytics delay, and how the NWDAF 862 avoid updating its supported analytics delay in NRF frequently may be NWDAF-implementation specific.

The PCF 856 provides policy rules to control plane functions to enforce them, and may also support unified policy framework to govern network behavior. The PCF 856 may also implement a front end to access subscription information relevant for policy decisions in a UDR 859 of the UDM 858. In addition to communicating with functions over reference points as shown, the PCF 856 exhibit an Npcf service-based interface.

The UDM 858 handles subscription-related information to support the network entities' handling of communication sessions, and stores subscription data of UE 802. For example, subscription data may be communicated via an N8 reference point between the UDM 858 and the AMF 844. The UDM 858 may include two parts, an application front end and a UDR 859. The UDR 859 may store subscription data and policy data for the UDM 858 and the PCF 856, and/or structured data for exposure and application data (including PFDs for application detection, application request information for multiple UEs 802) for the NEF 852. The Nudr service-based interface may be exhibited by the UDR 859 to allow the UDM 858, PCF 856, and NEF 852 to access a particular set of the stored data, as well as to read, update (e.g., add, modify), delete, and subscribe to notification of relevant data changes in the UDR 859. The UDM 858 may include a UDM-FE, which is in charge of processing credentials, location management, subscription management and so on. Several different front ends may serve the same user in different transactions. The UDM-FE accesses subscription information stored in the UDR 859 and performs authentication credential processing, user identification handling, access authorization, registration/mobility management, and subscription management. In addition to communicating with other NFs over reference points as shown, the UDM 858 may exhibit the Nudm service-based interface.

Edge Application Server Discovery Function (EASDF) 861 exhibits an Neasdf service-based interface, and is connected to the SMF 846 via an N88 interface. One or multiple EASDF instances may be deployed within a PLMN, and interactions between 5GC NF(s) and the EASDF 861 take place within a PLMN. The EASDF 861 includes one or more of the following functionalities: registering to NRF 854 for EASDF 861 discovery and selection; handling the DNS messages according to the instruction from the SMF 846; and/or terminating DNS security, if used. Handling the DNS messages according to the instruction from the SMF 846 includes one or more of the following functionalities: receiving DNS message handling rules and/or BaselineDNSPattern from the SMF 846; exchanging DNS messages from/with the UE 802; forwarding DNS messages to C-DNS or L-DNS for DNS query; adding EDNS client subnet (ECS) option into DNS query for an FQDN; reporting to the SMF 846 the information related to the received DNS messages; and/or buffering/discarding DNS messages from the UE 802 or DNS Server. The EASDF has direct user plane connectivity (e.g., without any NAT) with the PSA UPF over N6 for the transmission of DNS signaling exchanged with the UE. The deployment of a NAT between EASDF 861 and PSA UPF 848 may or may not be supported. Additional aspects of the EASDF 861 are discussed in [TS23548].

AF 860 provides application influence on traffic routing, provide access to NEF 852, and interact with the policy framework for policy control. The AF 860 may influence UPF 848 (re)selection and traffic routing. Based on operator deployment, when AF 860 is considered to be a trusted entity, the network operator may permit AF 860 to interact directly with relevant NFs. In some implementations, the AF 860 is used for edge computing implementations. The AF 860 may also subscribe to, or request network data analytics as defined in [TS23288], such as end-to-end data volume transfer time analytics, DN performance analytics, network performance analytics, UE mobility analytics, WLAN performance analytics, sensing service analytics, and/or the like. In some examples, the analytics can be used to assist its AI/ML operations.

An NF that needs to collect data from an AF 860 may subscribe/unsubscribe to notifications regarding data collected from an AF 860, either directly from the AF 860 or via NEF 852. The data collected from an AF 860 can be used as input for analytics by the NWDAF 862. The details for the data collected from an AF 860 as well as interactions between NEF 852, AF 860 and NWDAF 862 are described in [TS23288].

The 5GC yx40 may enable edge computing by selecting operator/3rd party services to be geographically close to a point that the UE 802 is attached to the network. This may reduce latency and load on the network. In edge computing implementations, the 5GC 840 may select a UPF 848 close to the UE 502 and execute traffic steering from the UPF 848 to DN 836 via the N6 interface. This may be based on the UE subscription data, UE location, and information provided by the AF 860, which allows the AF 860 to influence UPF (re) selection and traffic routing.

The data network (DN) 836 may represent various network operator services, Internet access, or third party services that may be provided by one or more servers including, for example, application (app)/content server 838. The DN 836 may be an operator external public, a private PDN, or an intra-operator packet data network, for example, for provision of IMS services. In this example, the app server 838 can be coupled to an IMS via an S-CSCF or the I-CSCF. In some implementations, the DN 836 may represent one or more local area DNs (LADNs), which are DNs 836 (or DN names (DNNs)) that is/are accessible by a UE 802 in one or more specific areas. Outside of these specific areas, the UE 802 is not able to access the LADN/DN 836.

Additionally or alternatively, the DN 836 may be an edge DN 836, which is a (local) DN that supports the architecture for enabling edge applications. In these examples, the app server 838 may represent the physical hardware systems/devices providing app server functionality and/or the application software resident in the cloud or at an edge compute node that performs server function(s). In some examples, the app/content server 838 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 804 or RAN nodes 814. For example, the edge compute nodes can provide a connection between the RAN 804 and UPF 848 in the 5GC 840. The edge compute nodes can use one or more NFV instances instantiated on virtualization infrastructure within the edge compute nodes to process wireless connections to and from the RAN 814 and UPF 848.

In some implementations, the edge compute nodes provide a distributed computing environment for application and service hosting, and also provide storage and processing resources so that data and/or content can be processed in close proximity to subscribers (e.g., users of UEs 802) for faster response times. The edge compute nodes also support multitenancy runtime and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 802, CN 840, DN 836, and/or server(s) 838, or vice versa. For example, a device application or client application operating in a UE 802 may offload application tasks or workloads to one or more edge compute nodes. In another example, an edge compute node may offload application tasks or workloads to a set of UEs 802 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 802. The VI of the edge compute nodes provide virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001, ETSI GS MEC 003, ETSI GS MEC 009, ETSI GS MEC 010-1, ETSI GS MEC 010-2, ETSI GS MEC 011, ETSI GS MEC 012, ETSI GS MEC 013, ETSI GS MEC 014, ETSI GS MEC 015, ETSI GS MEC 016, ETSI GS MEC 021, ETSI GR MEC 024, ETSI GS MEC 028, ETSI GS MEC 029, ETSI MEC GS 030, and ETSI GR MEC 031 (collectively referred to herein as “[MEC]”). This example implementation (and/or in any other example implementation discussed herein) may also include NFV and/or other like virtualization technologies such as those discussed in ETSI GR NFV 001, ETSI GS NFV 002, ETSI GR NFV 003, ETSI GR NFV 003, ETSI GS NFV 006, ETSI GS NFV-INF 001, ETSI GS NFV-INF 003, ETSI GS NFV-INF 004, ETSI GS NFV-MAN 001, and/or Israel et al., OSM Release FIVE Technical Overview, ETSI OPEN SOURCE MANO, OSM White Paper, 1st ed. (January 2019). Other virtualization technologies and/or service orchestration and automation platforms may be used such as, for example, those discussed in E2E Network Slicing Architecture, GSMA, Official Doc. NG.127, v1.0 (3 Jun. 2021), Open Network Automation Platform (ONAP) documentation, Release Istanbul, v9.0.1 (17 Feb. 2022), 3GPP Service Based Management Architecture (SBMA) as discussed in [TS28533].

In another example implementation, the ECT is and/or operates according to the O-RAN framework, as described in O-RAN Working Group 1 (Use Cases and Overall Architecture): O-RAN Architecture Description, O-RAN ALLIANCE WG1, O-RAN Architecture Description v09.00, Release R003 (June 2023); O-RAN Working Group 2 (Non-RT RIC and A1 interface WG) A1 interface: Application Protocol, v04.00, R003 (March 2023); O-RAN Working Group 2 (Non-RT RIC and A1 interface WG) A1 interface: General Aspects and Principles, v03.01, Release R003 (March 2023); O-RAN Working Group 2 AI/ML workflow description and requirements v01.03 O-RAN ALLIANCE WG2 (October 2021); O-RAN Working Group 2 (Non-RT RIC and A1 interface WG): R1 interface: General Aspects and Principles 5.0, v05.00, R003 (June 2023); O-RAN Working Group 2 (Non-RT RIC and A1 interface WG) Non-RT RIC Architecture, v03.00, Release R003 (June 2023); O-RAN Working Group 3 Near-Real-time RAN Intelligent Controller Architecture & E2 General Aspects and Principles, v03.01, Release R003 (June 2023); O-RAN Working Group 3, Near-Real-time Intelligent Controller, E2 Application Protocol (E2AP), v03.01, Release R003 (June 2023); O-RAN Working Group 3 Near-Real-time Intelligent Controller E2 Service Model (E2SM), v03.01, Release R003 (June 2023); O-RAN Working Group 3 Near-Real-time Intelligent Controller E2 Service Model (E2SM) KPM, v03.00, Release R003 (March 2023); O-RAN Working Group 3 Near-Real-time Intelligent Controller E2 Service Model (E2SM), Cell Configuration and Control, v01.01, Release R003 (March 2023); O-RAN Working Group 3 Near-Real-time Intelligent Controller E2 Service Model (E2SM) RAN Function Network Interface (NI) v01.00 (February 2020); O-RAN Working Group 3 Near-Real-time Intelligent Controller E2 Service Model (E2SM) RAN Control v03.00, Release R003 (June 2023); O-RAN Working Group 3 (Near-Real-time RAN Intelligent Controller and E2 Interface Working Group): Near-RT RIC Architecture, v04.00, Release R003 (March 2023) (collectively referred to as “[O-RAN]”).

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.222, 3GPP TS 23.401, 3GPP TS 23.434, 3GPP TS 23.501 (“[TS23501]”), 3GPP TS 23.502 (“[TS23502]”), 3GPP TS 23.503 (“[TS23503]”), 3GPP TS 23.548 (“[TS23548]”), 3GPP TS 23.558 (“[TS23558]”), 3GPP TS 23.682, 3GPP TR 23.700-98, 3GPP TS 28.104 (“[TS28104]”), 3GPP TS 28.105 (“[TS28105]”), 3GPP TS 28.312, 3GPP TS 28.532 (“[TS28532]”), 3GPP TS 28.533 (“[TS28533]”), 3GPP TS 28.535, 3GPP TS 28.536, 3GPP TS 28.538, 3GPP TS 28.541 (“[TS28541]”), 3GPP TS 28.545 (“[TS28545]”), 3GPP TS 28.550 (“[TS28550]”), 3GPP TS 28.554 (“[TS28554]”), 3GPP TS 28.622 (“[TS28622]”), 3GPP TS 29.122, 3GPP TS 29.222, 3GPP TS 29.522, 3GPP TR 28.908, 3GPP TS 33.122 (collectively referred to as “[5GEdge]”).

In another example implementation, the ECT operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies Examples of such edge computing/networking technologies include [MEC]; [O-RAN]; [5GEdge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

The interfaces of the 5GC 840 include reference points and service-based interfaces. A reference point, at least in some examples, is a point at the conjunction of two non-overlapping functional groups, elements, or entities. The reference points include: N1 (between the UE 802 and the AMF 844), N2 (between RAN 814 and AMF 844), N3 (between RAN 814 and UPF 848), N4 (between the SMF 846 and UPF 848), N5 (between PCF 856 and AF 860), N6 (between UPF 848 and DN 836), N7 (between SMF 846 and PCF 856), N8 (between UDM 858 and AMF 844), N9 (between two UPFs 848), N10 (between the UDM 858 and the SMF 846), N11 (between the AMF 844 and the SMF 846), N12 (between AUSF 842 and AMF 844), N13 (between AUSF 842 and UDM 858), N14 (between two AMFs 844; not shown), N15 (between PCF 856 and AMF 844 in case of a non-roaming scenario, or between the PCF 856 in a visited network and AMF 844 in case of a roaming scenario), N16 (between two SMFs 846; not shown), and N22 (between AMF 844 and NSSF 850). Other reference point representations not shown in FIG. 8 can also be used, such as any of those discussed previously and/or as discussed in [TS23501].

The service-based representation of FIG. 8 represents NFs within the control plane that enable other authorized NFs to access their services. A service-based interface (SB1), at least in some examples, is an interface over which an NF can access the services of one or more other NFs. In some implementations, the service-based interfaces are API-based interfaces (e.g., northbound APIs, southbound APIs, HTTP/2, RESTful, SOAP, A1AP, E2AP, and/or any other API, web service, application layer and/or other communication protocol, such as any of those discussed herein) that can be used by an NF to call or invoke a particular service or service operation. The SBIs include: Namf (SBI exhibited by AMF 844), Nsmf (SBI exhibited by SMF 846), Nnef (SBI exhibited by NEF 852), Npcf (SBI exhibited by PCF 856), Nudm (SBI exhibited by the UDM 858), Naf (SBI exhibited by AF 860), Nnrf (SBI exhibited by NRF 854), Nnssf (SBI exhibited by NSSF 850), Nausf (SBI exhibited by AUSF 842). Other service-based interfaces (e.g., Nudr, N5g-eir, and Nudsf) not shown in FIG. 8 can also be used, such as any of those discussed previously and/or as discussed in [TS23501].

Although not shown by FIG. 8, the system 800 may also include NFs that are not shown such as, for example, UDR 859, Unstructured Data Storage Function (UDSF), NSACF, Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 860, Time Sensitive Communication and Time Synchronization Function (TSCTSF), DCCF, Analytics Data Repository Function (ADRF), MFAF, Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

A 5G system (5GS) (see e.g., FIG. 8, discussed infra) can include an NWDAF (e.g., NWDAF 862 in FIG. 8), which is a network function (NF) capable of collecting data from user equipment (UE) (e.g., UE 802 in FIG. 8), other NFs, Operations, Administration and Maintenance (OAM) entities, application functions (AFs) (e.g., AF 860 in in FIG. 8), data networks (e.g., DN 836 in FIG. 8), cloud computing services, edge compute nodes and/or edge networks, and/or other entities/elements that can be used for analytics.

The 5GS architecture allows an NWDAF 862 to collect data from any NF (e.g., any NF within a 5G core network (5GC) 840 in FIG. 8) over an Nnf service-based interface associated with the NF(s). The NWDAF 862 belongs to the same PLMN as the NF that provides the data. The Nnf interface is defined for the NWDAF 862 to request subscription to data delivery for a particular context, cancel subscription to data delivery, and request a specific report of data for a particular context. The 5GS architecture also allows the NWDAF 862 to retrieve management data from an OAM entity by invoking OAM services.

The 5GS architecture also allows the NWDAF 862 to collect data from any NF or OAM using the DCCF 863 (see e.g., FIG. 9) with associated Ndccf services (see e.g., [TS23288] § 8.2). The 5GS architecture also allows the NWDAF 862 and the DCCF 863 to collect data from an NWDAF 862 with associated Nnwdaf_DataManagement services (see e.g., FIG. 9, and [TS23288] § 7.4). The 5GS architecture allows an MFAF 865 to fetch data from an NWDAF 862 with associated Nnwdaf_DataManagement service (see e.g., FIG. 9, and [TS23288] § 7.4). An Nnwdaf_AnalyticsSubscription service enables NF service consumers (NFc) to subscribe/unsubscribe for different type of analytics from an NWDAF 862 (see e.g., [TS23288] § 7.2). An Nnwdaf_AnalyticsInfo service enables the NFc to request and get different type of analytics information from an NWDAF 862 and/or enables an NWDAF 862 to request transfer of analytics context from another NWDAF 862 (see e.g., clause 7.3 of [TS23288]).

FIG. 9 depicts an example data collection architecture 901 using data collection coordination. The data collection architecture includes an NWDAF 862, a Data Collection Coordination Function (DCCF) 863, a messaging framework 864 that includes a Messaging Framework Adaptor Function (MFAF) 865, and a network node/NF 950, which can be or include an NRF (e.g., NRF 854 of FIG. 8), UDM (e.g., UDM 858 of FIG. 8), and/or a Binding Support Function (BSF) (see e.g., [TS23502]). Various DCCF services are discussed in clause 8 of [TS23288], and various MFAF services are discussed in clause 9 of [TS23288].

The NWDAF 862 is communicatively coupled with the MFAF 865 via an Nmfaf interface, and communicatively coupled with the DCCF 863 via an Ndccf interface. The Ndccf interface is defined for the NWDAF 862 to support subscription request(s) for data delivery from a DCCF 863, to cancel subscription to data delivery, and to request a specific report of data. If the data is not already being collected, the DCCF 863 requests the data from the Data Source (e.g., any NF) using Nnf services (e.g., via the Nnf interface). The DCCF 863 may collect the data and deliver it to the NWDAF 862 (e.g., via the Ndccf interface), or the DCCF 863 may rely on the messaging framework 864 to collect data from the NF and deliver it to the NWDAF 862. The DCCF 863 is communicatively coupled with the MFAF 865 via an Nmfaf interface.

FIG. 9 also depicts an example network data analytics exposure architecture 902 using data collection coordination, which includes the same NFs as discussed previously. The 5GS architecture allows any NF to request network analytics information from NWDAF containing an analytics logical function (AnLF) 862a (see e.g., architecture 904) via the Nnfdaf interface. Analytics exposure to an NWDAF service consumer can take place using, for example, analytics subscribe/notify service operations (see e.g., [TS23288] §§ 6.1.1.1, 7.2), request/response service operations (see e.g., [TS23288] §§ 6.1.2.1, 7.3), via the DCCF 863 (see e.g., [TS23288] §§ 6.1.4.2, 7.4), via the MFAF 865 and/or messaging framework 864 (see e.g., [TS23288] §§ 6.1.4.4, 7.4).

In some examples, the NWDAF 862 belongs to the same PLMN as the NF that consumes the analytics information (e.g., am NWDAF consumer). The Nnwdaf interface is defined for 5GC NFs, to request subscription to network analytics delivery for a particular context, to cancel subscription to network analytics delivery, and to request a specific report of network analytics for a particular context. In some examples, the 5GS architecture also allows other consumers (e.g., OAM and/or charging enablement function (CEF)) to request network analytics information from NWDAF 862. The contents of the analytics exposure includes the input parameters listed in [TS23288] §§ 6.1.3, 7 and/or as discussed herein. These input parameters are provided by the consumers of the Nnwdaf_AnalyticsSubscription_Subscribe and/or Nnwdaf_AnalyticsInfo_Request service operations described in clause 7 of [TS23288].

The 5GS architecture allows the NWDAF 862 and DCCF 863 to request historical analytics (including historical sensing service analytics) from an NWDAF 862 with associated Nnwdaf_DataManagement services (see e.g., [TS23288] §§ 6.1.4.3, 7.4). The 5GS architecture allows the MFAF 865 and/or messaging framework 864 to fetch historical analytics (including historical sensing service analytics) from an NWDAF 862 with associated Nnwdaf_DataManagement service (see e.g., [TS23288] §§ 6.1.4.5, 7.4).

Additionally or alternatively, the 5GS architecture allows any NF to obtain analytics from an NWDAF 862 using the DCCF 863 with associated Ndccf services (see e.g., [TS23288] §§ 6.1.4.2, 8.2). As shown by FIG. 9, the Ndccf interface is defined for any NF to support subscription request(s) to network analytics (e.g., NWDAF 862), to cancel subscription for network analytics, and to request specific report(s) of network analytics. If the analytics is not already being collected, the DCCF 863 requests the analytics from the NWDAF 862 using Nnwdaf services. The DCCF 863 may collect the analytics and deliver it to the NF, or the DCCF 863 may rely on the messaging framework 864 to collect analytics and deliver it to the NF.

FIG. 9 also depicts an example data storage architecture 903 for analytics and collected data, which includes an NF, DCCF 863, MFAF 865 in the messaging framework 864, and an Analytics Data Repository Function (ADRF) 866. The 5GS architecture allows the ADRF 866 to store and retrieve the collected data and analytics in one or more databases 867, which may implement any suitable database management system.

The ADRF 866 exposes Nadrf services (e.g., via an Nadrf interface) for storage and retrieval of data by other NFs (e.g., NWDAF 862, and/or any other NF, such as any of those discussed herein) which access the data using Nadrf services. For example, data may be stored in the ADRF 866 a consumer by sending the ADRF 866 an Nadrf_DataManagement_StorageRequest containing the data or analytics to be stored. In some examples, the Nadrf_DataManagement_StorageRequest sent by a service consumer can include the data to be stored, data collection timestamp(s), analytics with timestamp, service operation, analytics specification or data specification, storage handling information, DataSetTag, and/or other suitable information. The ADRF response provides and/or sends an Nadrf_DataManagement_StorageRequest Response message to the consumer with a result indication. As examples, the response can include an indication that data and/or analytics is stored, whether the ADRF 866 determined that data or analytics is already stored, the storage approach, and/or other suitable information such as any of those discussed herein.

A consumer sending an Nadrf_DataManagement_RetrievalRequest request to the ADRF 866 to retrieve data or analytics for a storage transaction identifier or a fetch instructions received from the ADRF 866 in an Nadrf_DataManagement_RetrievalNotify. The ADRF 866 determines the availability of the data or analytics in its repository and sends either the data or analytics in a response to the consumer.

ML models may be stored in the ADRF 866 by a consumer sending the ADRF 866 an Nadrf_MLModelManagement_StorageRequest containing the ML model or ML model address to be stored. The ADRF response provides a result indication. An ML model may be deleted from the ADRF 866 by a consumer sending an Nadrf_MLModelManagement_Delete request. The ADRF response provides a result indication.

Based on the NF request or configuration on the DCCF 863, the DCCF 863 may determine or identify the ADRF 866 and interact directly or indirectly with the ADRF 866 to request or store data. Direct interactions involve the DCCF 863 requesting to store data in the ADRF 866 via an Nadrf service, or via an Ndccf_DataManagement_Notify (e.g., when ADRF 866 requested data collection notification via DCCF 863). In addition, the DCCF 863 retrieves data from the ADRF 866 via an Nadrf service. Indirect interactions involve the DCCF 863 requesting that the messaging framework 864 to store data in the ADRF 866 via an Nadrf service or via an Nmfaf_3daDataManagement_Configure service. The messaging framework 864 may contain one or more adaptors that translate between 3GPP defined protocols (e.g., MFAF 865 and/or some other adaptors). An NFc may specify in requests to the DCCF 863 that data provided by a data source needs to be stored in the ADRF 866. The ADRF 866 stores data received in an Nadrf_DataManagement_StorageRequest sent directly from an NF, or data received in an Ndccf_DataManagement_Notify, Nmfaf_3caDataManagement_Notify, or Nnwdaf_DataManagement_Notify from the DCCF 863, MFAF 865, and/or from the NWDAF 862. The ADRF 866 checks if the data consumer is authorized to access ADRF services and provides the requested data using the procedures specified in clause 7.1.4 of [TS23501].

Data collection coordination is supported by a DCCF 863 or an NWDAF 862. The data consumer may use an NRF 854 to perform NF discovery and selection to find a DCCF 863 that can coordinate data collection (DCCF discovery principles are defined in [TS23501] § 6.3.19). In some examples, data consumers send requests for data to the DCCF 863 rather than directly to the NF data source. Whether the data consumers directly contacts the NF data source or goes via the DCCF 863 is based on configuration of the data consumers and/or can be based on use case and/or implementation. For the data consumer and each notification endpoint in a data request, the data consumer may specify formatting and processing instructions that determine how the data is to be provided. Upon receiving a request from a data consumer, the selected DCCF 863 determines the NF instance that can be a data source if the data source is not indicated in the data consumer's request. The DCCF 863 may also select an ADRF 866 if the data is to be stored in an ADRF 866 and an ADRF 866 endpoint is not indicated in the data consumer's request. To retrieve data for a specific UE, the NRF 854, UDM or BSF can provide the DCCF 863 with the identity of the data source using the services indicated in table 5A.2-1 in [TS23888]. In some implementations, the SSMF 870, one or more RANs 804, and/or any other NF(s) discussed herein can be a data source and/or a data consumer.

The DCCF 863 keeps track of the data actively being collected from the data sources it is coordinating. It may do so by maintaining a record of the active prior requests it sends to each data source. If an NWDAF 862 subscribes for data directly with a data source, or a data source has stored data in an ADRF 866, the NWDAF 862 or ADRF 866 may register the data collection profile with the DCCF 863. The data collection profile may include one or more of the following parameters: “Service Operation” identifies the service used to collect the data or analytics from a data source (e.g., Namf_EventExposure_Subscribe or Nnwdaf_AnalyticsSubscription_Subscribe); “Analytics/Data Specification” is the “Service Operation” specific parameters that identify the collected data (e.g., analytics ID(s), event ID(s), target of analytics reporting, target of event reporting, analytics filter, event filter, and/or the like); NWDAF ID or ADRF ID specifies the ADRF 866 or NWDAF 862, which registers data collection profile; and/or the like. The DCCF 863 may then determine certain historical data may be available in the NWDAF 862 or ADRF 866 and coordinate collection of data from the NWDAF 862 or ADRF 866 based on the data collection profile.

When the DCCF 863 receives a request for data, it determines the status of data collection from the data source. If parameters in a request for data from a data consumer match those in a prior request or in a data collection profile registration, the DCCF 863 may determine that the requested data is already being collected from a data source or that a prior subscription to a data source may be modified to in addition satisfy the requirements of the new data request from a data consumer. This status is used in clause 5A.3 of [TS23888] to deliver data to the data consumer and notification endpoints.

For persisting event exposure subscriptions for long-lived data collection, the DCCF 863 may subscribe to the UDM 858 to receive event notifications even if a data source that serves a UE 802 changes. The DCCF 863 may subscribe to the NRF 854 to receive event notifications if a data source changes (e.g., because of a NF life-cycle event).

In some examples, a DCCF 863 can support multiple data sources, data consumers, and/or message frameworks 864. In other examples, each data source NF or set of data source NFs may be associated with only one DCCF 863 instance or DCCF set to avoid duplicate data collection. The number of data sources, data consumers, and/or message frameworks 864 associated with a DCCF 863 can be based on use case and/or may be implementation-specific, and in some examples, can dynamically change based on various conditions, parameters, and/or criteria.

A DCCF 863 may use the same mechanisms described in [TS23888] § 6.2.2.1 to determine an AMF 844 and/or SMF 846 to retrieve data related to “any UE”. If a data consumer requests to collect data for any UE in an area of interest, the data consumer shall first determine all DCCFs 863 covering the area of interest and then contact these DCCFs 863 to request for data collection.

FIG. 9 depicts an example trained ML model provisioning architecture 904. The NWDAF 862 may contain an analytics logical function (AnLF) 862a and/or a model training logical function (MTLF) 862b. The NWDAF 862 can contain only an MTLF 862b, only an AnLF 862a, or both logical functions 862a, 862b. The 5GS architecture allows an NWDAF containing an AnLF 862a (also referred to herein as “NWDAF-ANLF 862a”) to use trained ML model provisioning services from the same or different NWDAF containing an MTLF 862b (also referred to herein as “NWDAF-MTLF 862b”). The Nnwdaf interface is used by the NWDAF-AnLF 862a to request and subscribe to trained ML model provisioning services provided by the NWDAF-MTLF 862b. The NWDAF 862 provides an Nnwdaf_MLModelProvision service enables an NFc to receive a notification when an ML model matching the subscription parameters becomes available in the NWDAF-MTLF 862b (see e.g., clause 7.5 of [TS23288]). The NWDAF 862 provides an Nnwdaf_MLModelInfo service that enables an NFc to request and get ML Model information from the NWDAF-MTLF 862b (see e.g., clause 7.6 of [TS23288].

The AnLF 862a is a logical function in the NWDAF 862 that performs and/or generates inferences, derives analytics information (e.g., derives statistics, inferences, and/or predictions based on analytics consumer requests), and/or exposes analytics services (e.g., Nnwdaf_AnalyticsSubscription or Nnwdaf_AnalyticsInfo). Analytics information are either statistical information of past events and/or predictive information (e.g., inferences and/or data based on inferences). For purposes of the present disclosure, the term “inference” refers to the process of using trained AI/ML model(s) to generate statistical inferences, statistical information, predictive information (or predictions), decisions, probabilities, probability distributions, actions, configurations, policies, data analytics, outcomes, optimizations, and/or the like based on new and/or unseen data (e.g., “input inference data”).

The MTLF 862b is a logical function in the NWDAF 862 that trains AI/ML models and exposes new training services (e.g., providing trained ML model) as defined in clauses 7.5 and 7.6 of [TS23288]. In some examples, the AnLF 862a can operate AI/ML model(s) trained by the MTLF 862b and/or the MTLF 862b can train AI/ML model(s) to be deployed to one or more NFs. AFs 860, and/or non-3GPP entities/elements.

Since multiple NWDAF 862 instances may be deployed in a network, an NFc can utilize the NRF 854 to discover NWDAF 862 instance(s) unless NWDAF information is available by other means (e.g., locally configured on NFcs). NFcs may make an additional query to the UDM 858, when supported. An NWDAF selection function in an NFc selects an NWDAF 862 instance based on the available NWDAF 862 instances.

In order to support NFs to discover and select an NWDAF 862 instance containing MTLF 862b, an NWDAF 862 instance containing AnLF 862a, or both, that is/are able to provide the required service(s) (e.g., analytics exposure and/or ML model provisioning) for the required type of analytics, each NWDAF 862 instance may provide a list of supported analytics ID(s) (e.g., possibly per supported service) when registering to the NRF 854, in addition to other NRF 854 registration elements of the NF profile. NFs requiring the discovery of an NWDAF 862 instance that provides support for some specific service(s) for a specific type of analytics may query the NRF 854 for NWDAFs 862 supporting the required service(s) and the required analytics ID(s). The consumers, (e.g., NFs, AFs 860, and/or OAM entities) decide how to use the data analytics provided by NWDAF 862. The interactions between NF(s) and the NWDAF 862 take place within a PLMN.

The NRF 854 may return one or more candidate NWDAF 862 instance(s) and each candidate NWDAF 862 instance (based on its registered profile) supports the analytics ID with a time that is less than or equal to a supported analytics delay. The following factors may be considered by an NFc for NWDAF 862 selection: S-NSSAI(s); analytics ID(s); supported service(s), possibly with their associated analytics IDs; NWDAF serving area information (e.g., a list of TAIs for which the NWDAF 862 can provide analytics, trained ML models and/or data, and/or other NWDAF services); NF type of the data source when DCCF 863 is hosted by an NWDAF 862; NF set ID of the data source; supported analytics delay of the requested analytics ID(s) (see clause 6.2.6.2 of [TS23288]); and/or for multiple deployed NWDAF 862 instances, NWDAF capabilities (e.g., analytics aggregation capability, analytics metadata provisioning capability, ML model training capabilities, ML model deployment capabilities, and/or the like) When selecting an NWDAF 862 for ML model provisioning, the following additional factors may be considered by the NWDAF 862: the ML model filter information parameters, such as S-NSSAI(s) and area(s) of interest (AoI(s)) (see e.g., clause 5.2 of [TS23288]) for the trained ML model(s) per analytics ID(s) and ML model interoperability indicator per analytics ID, if available. When selecting an NWDAF 862 that supports federated learning (FL), the following additional factors may be considered by the NWDAF 862: time period of interest (e.g., time interval [start . . . end], during which the FL will be performed); when selecting FL client: FL capability type as FL client per Analytics ID and/or data available by the FL client; and when selecting FL server: FL capability type as FL server per analytics ID and/or the ML model filter information parameters S-NSSAI(s) and AoI(s) (see e.g., clause 5.2 of [TS23288]) for the trained ML model(s) per analytics ID(s), if available.

FIG. 10 schematically illustrates a wireless network 600. The wireless network 600 includes a UE 1002 in wireless communication with a NAN 1004. The UE 1002 may be the same or similar to, and substantially interchangeable with any of the of the UEs discussed herein such as, for example, UE 802, hardware resources 1100, and/or any other UE discussed herein. The NAN 1004 may be the same or similar to, and substantially interchangeable with any of the NANs discussed herein such as, for example, AP 806, NANs 814, RAN 804, hardware resources 1100, and/or any other NAN(s) discussed herein.

The UE 1002 may be communicatively coupled with the NAN 1004 via connection 1006. The connection 1006 is illustrated as an air interface to enable communicative coupling, and can be consistent with cellular communications protocols such as an LTE protocol or a 5G NR protocol operating at mm Wave or sub-6 GHZ frequencies.

The UE 1002 includes a host platform 1008 coupled with a modem platform 1010. The host platform 1008 includes application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations includes transport (for example UDP) and Internet (e.g., IP) operations

The protocol processing circuitry 1014 may implement one or more of layer operations to facilitate transmission or reception of data over the connection 1006. The layer operations implemented by the protocol processing circuitry 1014 includes, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which includes or connect to one or more antenna panels 1026. Briefly, the transmit circuitry 1018 includes a digital-to-analog converter, mixer, intermediate frequency (IF) components, and/or the like; the receive circuitry 1020 includes an analog-to-digital converter, mixer, IF components, and/or the like; the RF circuitry 1022 includes a low-noise amplifier, a power amplifier, power tracking components, and/or the like; RFFE 1024 includes filters (e.g., surface/bulk acoustic wave filters), switches, antenna tuners, beamforming components (e.g., phase-array antenna components), and/or the like The selection and arrangement of the components of the transmit circuitry 1018, receive circuitry 1020, RF circuitry 1022, RFFE 1024, and antenna panels 1026 (referred generically as “transmit/receive components” or “Tx/Rx components”) may be specific to details of a specific implementation such as, for example, whether communication is TDM or FDM, in mmWave or sub-6 gHz frequencies, and/or the like. In some examples, the transmit/receive components may be arranged in multiple parallel transmit/receive chains, may be disposed in the same or different chips/modules, and/or the like.

In some examples, the protocol processing circuitry 1014 includes one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some examples, the antenna panels 1026 may receive a transmission from the NAN 1004 by receive-beamforming signals received by a set of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some examples, the transmit components of the UE 1004 may apply a spatial filter to the data to be transmitted to form a transmit beam emitted by the antenna elements of the antenna panels 1026.

Similar to the UE 1002, the NAN 1004 includes a host platform 1028 coupled with a modem platform 1030. The host platform 1028 includes application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, UL and DL dynamic radio resource management, and data packet scheduling.

Examples of the antenna elements of the antenna panels 1026 and/or the antenna elements of the antenna panels 1046 include planar inverted-F antennas (PIFAs), monopole antennas, dipole antennas, loop antennas, patch antennas, Yagi antennas, parabolic dish antennas, omni-directional antennas, and/or the like.

FIG. 11 illustrates components capable of reading instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For examples where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, and/or the like.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, and/or the like), cellular communication components, NFC components, Bluetooth® components, WiFi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

In some implementations, the peripheral devices 1104 may represent one or more sensors (also referred to as “sensor circuitry”). The sensor circuitry includes devices, modules, or subsystems whose purpose is to detect events or changes in its environment and send the information (sensor data) about the detected events to some other a device, module, subsystem, and/or the like. Individual sensors may be exteroceptive sensors (e.g., sensors that capture and/or measure environmental phenomena and/external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node or platform); pressure sensors; barometric pressure sensors; gravimeters; altimeters; image sensors/image capture devices (e.g., visible and/or non-visible light cameras, active-pixel sensors, passive-pixel sensors, quanta image sensors, gamma (γ) cameras, x-ray sensor arrays, and/or the like); image-forming devices, optical telescopes, LiDAR sensors; radar sensors, sonar sensors, ToF cameras, acoustic sensors, proximity sensors (e.g., infrared radiation detectors and the like); depth sensors, ambient light sensors; optical light sensors; ultrasonic transceivers; microphones; and the like.

Additionally or alternatively, the sensor circuitry includes the PEE sensor(s), such as energy/power meters (e.g., analog, digital, and/or smart electric meters, wattmeter including current coils and voltage coils, volt-ampere meters, reactive power meters, power quality analyzers, and/or the like), voltage meters (e.g., analog voltmeters, digital voltmeters, moving-coild voltmeters, moving-iron voltmeters, electrostatic voltmeters, vacuum tube voltmeters, digital storage oscilloscopes, high-voltage probes, AC voltage sensors, digital panel meters, and/or the like), alternating current (AC) and/or direct current (DC) meters/sensors (e.g., open-loop and/or closed loop hall effect sensors, Rogowski coil sensors, current transformers, shunt resistors, resistor-based current sensors, zero-flux current sensors, digital current sensors, fiber optic current sensors, and/or the like), AC frequency measurement sensors (e.g., electromagnetic frequency meters and/or induction-based AC frequency measurement sensors, DSP-based sensors, vibration frequency sensors, piezoelectric sensors, optical frequency sensors, frequency counters, phase-locked loop (PLL) frequency detectors, resonant circuits, microcontroller-based frequency sensors, and/or the like), true power factor measurement devices, thermal environment sensors (e.g., temperature sensors, humidity sensors, and/or the like), and/or any other types of sensor(s) discussed herein. Examples of the temperature sensors include resistance temperature detectors (RTDs), thermocouples, thermistors (e.g., negative temperature coefficient (NTC) and/or positive temperature coefficient (PTC) thermistors), IR sensors, bimetallic temperature sensors, fiber optic temperature sensors, digital temperature sensors (IC sensors), gas thermometers, hygrothermometers, and/or the like. Examples of humidity sensors include capacitive humidity sensors, resistive humidity sensors, gravimetric hygrometers, dew point sensors, hygrothermometers. Additionally or alternatively, the PEE sensor(s) 120 can include environmental monitoring sensors, which may include temperature sensors, humidity sensors, pressure sensors, light sensors and/or photodetectors (e.g., photodiodes, phototransistors, photovoltaic cells, photomultiplier tubes, light-dependent resistors, charge-coupled devices (CCDs), active-pixel sensors, avalanche photodiodes, photonic sensors, pyroelectric sensors, radiometers, and/or the like), air quality sensors (e.g., particulate matter (e.g., PM2.5 and PM10) sensors, gas sensors, particle counters, temperature and/or humidity sensors, and/or the like), and/or any other suitable sensor(s). Examples of gas sensors include carbon monoxide sensors, carbon dioxide sensors, ozone sensors, volatile organic compound sensors, nitrogen dioxide sensors, sulfur dioxide sensors, ammonia sensors, and/or the like.

Additionally or alternatively, the peripheral devices 1104 may represent one or more actuators, which allow a compute node, platform, machine, device, mechanism, system, or other object to change its state, position, and/or orientation, or move or control a compute node (e.g., node 1100), platform, machine, device, mechanism, system, or other object. The actuators comprise electrical and/or mechanical devices for moving or controlling a mechanism or system, and converts energy (e.g., electric current or moving air and/or liquid) into some kind of motion. As examples, the actuators can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms, projectile actuators/mechanisms, and/or audible sound generators, visual warning devices, and/or other like electromechanical components. The compute node 1100 may be configured to operate one or more actuators based on one or more captured events, instructions, control signals, and/or configurations received from a service provider, client device, and/or other components of a compute node or platform. Additionally or alternatively, the actuators are used to change the operational state, position, and/or orientation of the sensors.

### 3. Example Implementations

FIG. 12 shows an example process 1200 to be performed by a service producer. The process 1200 includes receiving, from a service consumer, a first message including an analytics identifier (ID) that corresponds to a sensing service and a set of input parameters related to the sensing service (operation 1201); obtaining collect, and/or aggregate analytics information based on the analytics ID and/or the set of input parameters (operation 1202), wherein the analytics information is generated based on collected data related to the sensing service; and sending, to the service consumer, a second message including the analytics information (operation 1203). In one example, the service producer is an NWDAF 862 or an NWDAF containing an AnLF 862a, and the service consumer is an SSMF 870. Additionally or alternatively, the service producer and/or the service consumer can be any combination of NFs including, for example, NWDAF 862. NWDAF-AnLF 862a, DCCF 863, MFAF 865, AF 860, NEF 852, NRF 854, and/or SSMF 870.

The example operations of process 1200 can be arranged in different orders, one or more of the depicted operations may be combined and/or divided/split into multiple operations, depicted operations may be omitted, and/or additional or alternative operations may be included in any of the depicted processes. Additional examples of the presently described methods, devices, systems, and networks discussed herein include the following, non-limiting example implementations. Each of the following non-limiting examples may stand on its own or may be combined in any permutation or combination with any one or more of the other examples provided below or throughout the present disclosure.

Example 1 includes a method of operating a service producer, the method comprising: receiving, from a service consumer, a first message including an analytics identifier (ID) that corresponds to a sensing service and a set of input parameters related to the sensing service; obtaining analytics information based on the analytics ID and the set of input parameters; and sending, to the service consumer, a second message including the analytics information.

Example 2 includes the method of example 1 and/or some other example(s) herein, wherein the analytics ID is “Analytics ID: sensing channel frequency response” and the analytics information includes: a channel frequency response for individual transmit (Tx) beam directions over one or more resource elements (REs) used for sensing signal transmission; and the one or more REs used for the individual Tx beam directions including potential beam repetitions within a symbol repetition interval (SRI).

Example 3 includes the method of example 2 and/or some other example(s) herein, wherein the set of input parameters includes one or more of: a set of Tx modulation symbols of one or more transmitted sensing signals; a set of Rx modulation symbols of one or more received echo signals; and a set of interpolation parameters or windowing parameters.

Example 4 includes the method of examples 1-3 and/or some other example(s) herein, wherein the analytics ID is “Analytics ID: Range-Doppler image” and the analytics information includes: a range-Doppler image for individual Tx beam directions; a range fast Fourier transform (FFT) size; and a Doppler FFT size.

Example 5 includes the method of example 4 and/or some other example(s) herein, wherein the set of input parameters includes one or more of: a channel frequency response for individual Tx beam directions over one or more REs used for sensing signal transmission; and the one or more REs used for the individual Tx beam directions including potential beam repetitions within an SRI.

Example 6 includes the method of examples 1-5 and/or some other example(s) herein, wherein the analytics ID is “Analytics ID: Range-Doppler image after beam integration” and the analytics information includes: a range-Doppler image taken after beam integration for individual Tx beam directions; a range FFT size; and a Doppler FFT size.

Example 7 includes the method of example 6 and/or some other example(s) herein, wherein the set of input parameters includes one or more of: a range-Doppler image taken after for individual Tx beam directions; the range FFT size; the Doppler FFT size; and a number of beam repetitions for each beam within an SRI.

Example 8 includes the method of examples 1-7 and/or some other example(s) herein, wherein the analytics ID is “Analytics ID: Delay-Doppler bins after CFAR” and the analytics information includes: one or more delay-Doppler bins in a two dimensional (2D) grid that have a predetermined constant false alarm rate (CFAR) and are likely to contain target objects; a range FFT size; and a Doppler FFT size.

Example 9 includes the method of example 8 and/or some other example(s) herein, wherein the set of input parameters includes one or more of: a range-Doppler image taken after beam integration for individual Tx beam directions; the range FFT size; the Doppler FFT size; and a set of CFAR processing parameters.

Example 10 includes the method of examples 4-9 and/or some other example(s) herein, wherein the range-Doppler image is a 2D periodogram calculated over a delay-Doppler grid, wherein the delay-Doppler grid has a grid size of the range FFT by the Doppler FFT.

Example 11 includes the method of examples 1-10 and/or some other example(s) herein, wherein the analytics ID is “Analytics ID: Detected targets in FoV” and the analytics information includes: a set of detected target objects in an field of view (FoV); and for each detected target object in the set of detected target objects: an existence detection, a range, a velocity, and angle information.

Example 12 includes the method of example 11 and/or some other example(s) herein, wherein the set of input parameters includes one or more of: one or more delay-Doppler bins in a two dimensional (2D) grid that have a predetermined constant false alarm rate (CFAR) and are likely to contain target objects; a range FFT size; a Doppler FFT size; and an angular resolution algorithm and corresponding parameters for the angular resolution algorithm.

Example 13 includes the method of example 12 and/or some other example(s) herein, wherein the angular resolution algorithm is estimation of signal parameters via rotational invariant techniques (ESPRIT), multiple signal classification (MUSIC), constant modulus algorithm (CMA), Capon method, Minimum Variance Distortionless Response (MVDR), Maximum Likelihood Estimation (MLE), iterative sparse asymptotic minimum variance (SAMV), Very-Long-Baseline Interferometry (VLBI), or Expectation-Maximization (EM) algorithm.

Example 14 includes the method of examples 2-13 and/or some other example(s) herein, wherein the set of input parameters includes one or more of: a field of view (FoV); a maximum desired detection range; a maximum desired detection velocity; a range resolution; a velocity resolution; an angle resolution; a sensing frame duration; a sensing radio bandwidth; a number and index of symbols in a frame used for signal transmission; a number and index of subcarriers in a bandwidth used for signal transmission; a number of Tx antenna elements; a number of Tx ports; a number of Rx antenna elements; a number of Rx ports; and the individual Tx beam directions to cover the FoV within the SRI.

Example 15 includes the method of examples 1-14 and/or some other example(s) herein, wherein the analytics information is generated based on collected data related to the sensing service.

Example 16 includes the method of example 15 and/or some other example(s) herein, wherein the collected data related to the sensing service includes one or more of raw received signal measurements, received signal power measurements, or received signal quality measurements, noisy time-variant frequency-selective channel frequency response for individual Tx beam directions, periodograms, results of CFAR processing, a set of delay-Doppler bins for individual Tx beams, and results of angular resolution processing of delay-Doppler bins.

Example 17 includes the method of examples 15-16 and/or some other example(s) herein, wherein the collected data related to the sensing service is collected by one or more radio access networks (RANs) or a sensing service management function (SSMF).

Example 18 includes the method of examples 1-17 and/or some other example(s) herein, wherein the first message is a analytics subscription message based on invocation of an Nnwdaf_AnalyticsSubscription_Subscribe service operation, and the second message is a notification message based on invocation of an Nnwdaf_AnalyticsSubscription_Notify service operation.

Example 19 includes the method of examples 1-17 and/or some other example(s) herein, wherein the first message is a analytics request message based on invocation of an Nnwdaf_AnalyticsInfo_Request service operation service operation, and the second message is a response message based on the invocation of the Nnwdaf_AnalyticsInfo_Request service operation service operation or a Nnwdaf_AnalyticsInfo_Response service operation service operation.

Example 20 includes the method of examples 1-19 and/or some other example(s) herein, wherein the service consumer is an SSMF, a data collection coordination function (DCCF), a Messaging Framework Adaptor Function (MFAF), an Application Function (AF), or a Network Exposure Function (NEF).

Example 21 includes the method of examples 1-20 and/or some other example(s) herein, wherein the service producer is a Network Data Analytics Function (NWDAF), an NWDAF containing an analytics logical function (AnLF), a DCCF, an MFAF, an AF, an NEF, or an SSMF.

Example 22 includes a method of providing sensing services related analytics identifiers (IDs) to identify sensing data and related analytics.

Example 23 includes the method of example 22 and/or some other example(s) herein and/or some other example(s) herein, wherein the analytics IDs include a Sensing Channel Frequency Response analytics ID, a Range-Doppler image (2D-Periodogram) analytics ID, a Range-Doppler image after beam integration analytics ID, a Delay-Doppler bins after CFAR per beam direction analytics ID, and/or a Detected targets in field of view (FoV) analytics ID.

Example 24 includes a method, comprising: receiving sensing data from a data collection coordination function (DCCF); determining analytical information based on the sensing data, wherein the analytical information is associated with one or more of: object detection, object range/speed/angular estimation, object tracking, object shape identification, and channel exploitation and channel resolving; and sending the analytical information to one or more network functions (NFs).

Example 25 includes the method of example 24 and/or some other example(s) herein and/or some other example(s) herein, wherein the sensing data includes received signal information or received signal power information.

Example 26 includes the method of examples 24-25 and/or some other example(s) herein and/or some other example(s) herein, wherein determining the analytical information includes utilizing an element-wise division between known transmitted modulated symbols and received modulated echoed symbols.

Example 27 includes the method of examples 24-26 and/or some other example(s) herein and/or some other example(s) herein, wherein determining the analytical information includes calculating a range-Doppler image.

Example 28 includes the method of examples 24-27 and/or some other example(s) herein and/or some other example(s) herein, wherein determining the analytical information includes determining beam integration for repeated beams within a sounding reference signal resource indicator (SRI).

Example 29 includes the method of examples 24-28 and/or some other example(s) herein and/or some other example(s) herein, wherein determining the analytical information includes determining constant false alarm rate (CFAR) information.

Example 30 includes the method of examples 24-29 and/or some other example(s) herein and/or some other example(s) herein, wherein determining the analytical information includes determining angular resolution information.

Example 31 includes the method of examples 24-30 and/or some other example(s) herein and/or some other example(s) herein, wherein the analytical information includes one or more of: a sensing channel frequency response, a periodogram, a periodogram after beam integration, a delay-Doppler bin after CFAR per beam direction, or a sensing result for a detected target.

Example 32 includes the method of examples 22-31 and/or some other example(s) herein and/or some other example(s) herein, wherein the method is performed by an NWDAF, an NWDAF containing an AnLF, a DCCF, an MFAF, an AF, an NEF, or an SSMF.

Example 33 includes one or more computer readable media comprising instructions, wherein execution of the instructions by processor circuitry is to cause the processor circuitry to perform the method of any one of examples 1-32. Example 34 includes a computer program comprising the instructions of example 33. Example 35 includes an Application Programming Interface defining functions, methods, variables, data structures, and/or protocols for the computer program of example 34. Example 36 includes an API or specification defining functions, methods, variables, data structures, protocols, and the like, defining or involving use of any of examples 1-32 or portions thereof, or otherwise related to any of examples 1-32 or portions thereof. Example 37 includes an apparatus comprising circuitry loaded with the instructions of example 33. Example 38 includes an apparatus comprising circuitry operable to run the instructions of example 33. Example 39 includes an integrated circuit comprising one or more of the processor circuitry of example 33 and the one or more computer readable media of example 33. Example 40 includes a computing system comprising the one or more computer readable media and the processor circuitry of example 33. Example 41 includes an apparatus comprising means for executing the instructions of example 33. Example 42 includes a signal generated as a result of executing the instructions of example 33. Example 43 includes a data unit generated as a result of executing the instructions of example 33. Example 44 includes the data unit of example Z10 and/or some other example(s) herein, wherein the data unit is a datagram, packet, frame, data segment, Protocol Data Unit (PDU), Service Data Unit (SDU), message, type length value (TLV), segment, block, cell, chunk, or a database object. Example 45 includes a signal encoded with the data unit of examples 43 and/or 44. Example 46 includes an electromagnetic signal carrying the instructions of example 33. Example 47 includes an apparatus comprising means for performing the method of any one of examples 1-32 and/or some other example(s) herein. Example 48 may include a signal in a wireless network as shown and described herein. Example 49 may include a method of communicating in a wireless network as shown and described herein. Example 50 may include a system for providing wireless communication as shown and described herein. Example 51 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 4. Terminology

For the purposes of the present document, the following terms and definitions are applicable to the examples and embodiments discussed herein. Additionally, the terminology discussed in 3GPP TR 21.905, [TS23501], and/or [TS23503] may also be applicable to the examples and embodiments discussed herein

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, epochs, iterations, stages, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation.” “In some implementations,” “in some examples”, and the like, each of which may refer to one or more of the same or different embodiments, implementations, and/or examples. Furthermore, the terms “comprising.” “including.” “having.” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled.” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence cither actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queuing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like. The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM″ at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface. The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRP” at least in some examples refers to an antenna array with one or more antenna elements available to a network located at a specific geographical location for a specific area. The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an CU, DU, and/or RU are physically separated from one another. Additionally or alternatively, the term “split architecture” at least in some examples refers to a RAN architecture such as those discussed in 3GPP TS 38.401, 3GPP TS 38.410, and 3GPP TS 38.473. The term “integrated architecture at least in some examples refers to an architecture in which an RU and DU are implemented on one platform, and/or an architecture in which a DU and a CU are implemented on one platform.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “network function” or “NF” at least in some examples refers to a functional block within a network infrastructure that has one or more external interfaces and a defined functional behavior. The term “network instance” at least in some examples refers to information identifying a domain; in some examples, a network instance is used by a UPF for traffic detection and routing. The term “network service” or “NS” at least in some examples refers to a composition or collection of NF(s) and/or network service(s), defined by its functional and behavioral specification(s). The term “NF service instance” at least in some examples refers to an identifiable instance of the NF service. The term “NF instance” at least in some examples refers to an identifiable instance of an NF. The term “NF service” at least in some examples refers to functionality exposed by an NF through a service-based interface and consumed by other authorized NFs. The term “NF service operation” at least in some examples refers to an elementary unit that an NF service is composed of. The term “NF service set” at least in some examples refers to a group of interchangeable NF service instances of the same service type within an NF instance; in some examples, the NF service instances in the same NF service set have access to the same context data. The term “NF set” at least in some examples refers to a group of interchangeable NF instances of the same type, supporting the same services and the same network slice(s); in some examples, the NF instances in the same NF Set may be geographically distributed but have access to the same context data.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and includes identifying communication partners, determining resource availability, and synchronizing communication. Examples of application layer protocols include HTTP, HTTPS, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (ISCSI), iSCSI Extensions for RDMA (iSER), Transport Layer Security (TLS), voice over IP (VOIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (uTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signalling Radio Bearers (SRBs) and Data Radio Bearers (DRBs); mobility functions/services; QoS management; and some sidelink specific services and functions over the Uu interface (see e.g., 3GPP TS 36.331 and 3GPP TS 38.331 (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 and/or 3GPP TS 38.323).

The term “radio link control layer”. “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 36.322 and 3GPP TS 38.322).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., 3GPP TS 36.321 and 3GPP TS 38.321).

The term “physical layer”, “PHY layer”, or “PHY” at least in some examples refers to a protocol layer or sublayer that includes capabilities to transmit and receive modulated signals for communicating in a communications network (see e.g., 3GPP TS 36.201 and 3GPP TS 38.201).

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wireless access technologies/RATs, wireline, wireline-cable, wireline broadband forum (wireline-BBF), Ethernet (see e.g., IEEE Standard for Ethernet, IEEE Std 802.3-2018 (31 Aug. 2018) (“[IEEE8023]”)) and variants thereof, fiber optics networks (e.g., ITU-T G.651, ITU-T G.652, Optical Transport Network (OTN), Synchronous optical networking (SONET) and synchronous digital hierarchy (SDH), and the like), digital subscriber line (DSL) and variants thereof, Data Over Cable Service Interface Specification (DOCSIS) technologies, hybrid fiber-coaxial (HFC) technologies, and/or the like. Examples of RATs (or RAT types) and/or communications protocols include Advanced Mobile Phone System (AMPS) technologies (e.g., Digital AMPS (D-AMPS), Total Access Communication System (TACS) and variants thereof, such as Extended TACS (ETACS), and the like); Global System for Mobile Communications (GSM) technologies (e.g., Circuit Switched Data (CSD), High-Speed CSD (HSCSD), General Packet Radio Service (GPRS), and Enhanced Data Rates for GSM Evolution (EDGE)); Third Generation Partnership Project (3GPP) technologies (e.g., Universal Mobile Telecommunications System (UMTS) and variants thereof (e.g., UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) and variants thereof (e.g., HSPA Plus (HSPA+)), Long Term Evolution (LTE) and variants thereof (e.g., LTE-Advanced (LTE-A), Evolved UTRA (E-UTRA), LTE Extra, LTE-A Pro, LTE LAA. MuLTEfire, and the like), Fifth Generation (5G) or New Radio (NR), narrowband IoT (NB-IOT). 3GPP Proximity Services (ProSe), and/or the like); ETSI RATs (e.g., High Performance Radio Metropolitan Area Network (HiperMAN), Intelligent Transport Systems (ITS) (e.g., ITS-G5, ITS-G5B, ITS-G5C, and the like), and the like); Institute of Electrical and Electronics Engineers (IEEE) technologies and/or WiFi (e.g., IEEE Standard for Local and Metropolitan Area Networks: Overview and Architecture, IEEE Std 802-2014, pp. 1-74 (30 Jun. 2014) (“[IEEE802]”), [IEEE80211], IEEE 802.15 technologies (e.g., IEEE 802.15.4 and variants thereof (e.g., ZigBee, WirelessHART, MiWi, ISA100.11a, Thread, IPV6 over Low power WPAN (6LoWPAN), and the like), IEEE 802.15.6 and/or the like), WLAN V2X RATS (e.g., [IEEE80211], IEEE Wireless Access in Vehicular Environments (WAVE) Architecture (IEEE 1609.0), IEEE 802.11bd, Dedicated Short Range Communications (DSRC), and/or the like), Worldwide Interoperability for Microwave Access (WiMAX) (e.g., IEEE 802.16), Mobile Broadband Wireless Access (MBWA)/iBurst (e.g., IEEE 802.20 and variants thereof), Wireless Gigabit Alliance (WiGig) standards (e.g., IEEE 802.11ad, IEEE 802.11ay, and the like), and so forth); Integrated Digital Enhanced Network (iDEN) and variants thereof (e.g., Wideband Integrated Digital Enhanced Network (WiDEN)); millimeter wave (mmWave) technologies/standards (e.g., wireless systems operating at 10-300 GHz and above 3GPP 5G); short-range and/or wireless personal area network (WPAN) technologies/standards (e.g., IEEE 802.15 technologies (e.g., as mentioned previously); Bluetooth and variants thereof (e.g., Bluetooth 5.3, Bluetooth Low Energy (BLE), and the like), WiFi-direct, Miracast, ANT/ANT+, Z-Wave, Universal Plug and Play (UPnP), low power Wide Area Networks (LPWANs), Long Range Wide Area Network (LoRA or LoRaWANTM), and the like); optical and/or visible light communication (VLC) technologies/standards (e.g., IEEE Std 802.15.7 and/or the like); Sigfox; Mobitex; 3GPP2 technologies (e.g., cdmaOne (2G), Code Division Multiple Access 2000 (CDMA 2000), and Evolution-Data Optimized or Evolution-Data Only (EV-DO); Push-to-talk (PTT), Mobile Telephone System (MTS) and variants thereof (e.g., Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) and variants thereof (e.g., DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel.” “transmission channel.” “data transmission channel,” “access channel,” “data access channel.” “link.” “data link.” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information. The term “carrier” at least in some examples refers to a modulated waveform conveying one or more physical channels (e.g., 5G/NR, E-UTRA, UTRA, and/or GSM/EDGE physical channels). The term “carrier frequency” at least in some examples refers to the center frequency of a cell. The term “subframe” at least in some examples at least in some examples refers to a time interval during which a signal is signaled. In some implementations, a subframe is equal to 1 millisecond (ms). The term “time slot” at least in some examples at least in some examples refers to an integer multiple of consecutive subframes. The term “superframe” at least in some examples at least in some examples refers to a time interval comprising two time slots.

The term “network address” or “address” at least in some examples refers to an identifier for a node or host in a computer network, and may be a unique identifier across a network and/or may be unique to a locally administered portion of the network.

The terms “instantiate,” “instantiation,” and the like at least in some examples refers to the creation of an instance. In some examples, the term “instance” refers to a concrete occurrence of an object, which may occur, for example, during execution of program code.

The term “reference point” at least in some examples refers to a conceptual point at the conjunction of two non-overlapping functional groups, elements, or entities. The term “service based interface” at least in some examples refers to a representation how a set of services is provided and/or exposed by a particular NF.

The term “service consumer” or “consumer” at least in some examples refers to an entity that consumes one or more services. The term “service producer” or “producer” at least in some examples refers to an entity that offers, serves, or otherwise provides one or more services. The term “service provider” or “provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”. “segment”, “block”, “cell”, “chunk”. “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a IEEE 802 protocol/standard (e.g., [IEEE80211] or the like), Type Length Value (TLV), and/or other like data structures. The term “packet” at least in some examples refers to an information unit identified by a label at layer 3 of the OSI reference model. In some examples, a “packet” may also be referred to as a “network protocol data unit” or “NPDU”. The term “protocol data unit” at least in some examples refers to a unit of data specified in an (N)-protocol layer and includes (N)-protocol control information and possibly (N)-user data.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element, or a data element that contains content. The term “data frame”, “data field”, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to a markup construct including a name-value pair that exists within a start tag or empty element tag. Attributes contain data related to its element and/or control the element's behavior.

The term “reference” at least in some examples refers to data useable to locate other data and may be implemented a variety of ways (e.g., a pointer, an index, a handle, a key, an identifier, a hyperlink, and/or the like).

The terms “configuration”, “policy”, “ruleset”, and/or “operational parameters”, at least in some examples refer to a machine-readable information object that contains instructions, conditions, parameters, criteria, data, metadata, and/or other information that is/are relevant to a component, device, system, network, service producer, service consumer, and/or other element/entity.

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi) set, random access list, hash consing, zipper data structure, and/or the like).

The term “performance indicator” at least in some examples refers to performance data aggregated over a group of NFs that is derived from performance measurements collected at the NFs that belong to the group. In some examples, performance indicators are derived, collected or aggregated according to an aggregation method identified in a performance indicator definition. The term “sensing data” at least in some examples refers to data derived from one or more sensors. Additionally or alternatively, the term “sensing data” at least in some examples refers to data derived from radio signals impacted (e.g., reflected, refracted, diffracted) by an object or environment of interest for sensing purposes. In some examples, the term “sensing data” and “sensing measurement” may refer to the same quantity and/or may be used interchangeably throughout the present disclosure.

The term “3GPP sensing data” at least in some examples refers to data derived from 3GPP radio signals impacted (e.g., reflected, refracted, diffracted) by an object or environment of interest for sensing purposes, and optionally processed within the 5GS. The term “non-3GPP sensing data” at least in some examples refers to data provided by non-3GPP sensors (e.g., video, LiDAR, sonar, radar, and/or the like) about an object or environment of interest for sensing purposes. The term “5G wireless sensing” at least in some examples refers to a 5GS feature providing capabilities to get information about characteristics of the environment and/or objects within the environment (e.g., shape, size, orientation, speed, location, distances or relative motion between objects, and/or the like) using NR RF signals and, in some cases, previously defined information available in EPC and/or E-UTRA.

The term “sensing assistance information” at least in some examples refers to information that is provided to 5G system and can be used to derive sensing result. In some examples, sensing assistance information does not contain 3GPP sensing data. Examples of sensing assistance information include map information, area information, a UE ID attached to or in the proximity of a sensing target, UE position information, UE velocity information, and/or the like.

The term “sensing contextual information” at least in some examples refers to information that is exposed with the sensing results by 5G system to a trusted third party which provides context to the conditions under which the sensing results were derived. In some examples, sensing contextual information does not contain 3GPP sensing data. Examples includes map information, area information, time of capture, UE location and ID. This contextual information can be required in scenarios where the sensing result is to be combined with data from other sources outside the 5GS.

The term “sensing group” at least in some examples refers to a set of sensing transmitters (Tx) and sensing receivers (Rx) whose location is known and whose sensing data can be collected synchronously.

The term “sensing measurement process” at least in some examples refers to a process of collecting sensing data. In some examples, the term “sensing measurement process”, “sensing job”, and/or “measurement job” may be used interchangeably throughout the present disclosure even though these terms may refer to different concepts.

The term “sensing receiver” or “sensing Rx” at least in some examples refers to an entity that receives sensing signal, which a sensing service will use in its operation. In some examples, a sensing Rx is an NR RAN node or a UE. In some examples, a sensing Rx can be located in the same or different entity as a sensing Tx.

The term “sensing result” at least in some examples refers to processed sensing data requested by a service consumer. In some examples, a sensing result includes processed 3GPP sensing data.

The term “sensing signals” at least in some examples refers to transmissions on a radio interface (e.g., 3GPP radio interface and/or non-3GPP radio interface) that can be used for sensing purposes. In some examples, sensing signals refers to NR RF signals.

The term “sensing transmitter” or “sensing Tx” at least in some examples refers to an entity that sends out the sensing signal(s), which a sensing service will use in its operation. In some examples, a sensing Tx is an NR RAN node or a UE. In some examples, a sensing Tx can be located in the same or different entity as a sensing Rx.

The term “target sensing service area” at least in some examples refers to a location, region, or area (e.g., in a Cartesian coordinate system, GNSS coordinate system, Barycentric coordinates, polar coordinate system, cylindrical coordinate system, spherical coordinate system, and/or the like) that is to be sensed by deriving characteristics of an environment and/or objects within the environment with a certain sensing service quality from the impacted (e.g., reflected, refracted, diffracted) wireless signals. In some examples, a target sensing service area can include indoor and/or outdoor environments.

The term “moving target sensing service area” at least in some examples refers to the case where a target sensing service area is moving according to the mobility of a target from sensing Tx's perspective.

The term “transparent sensing” at least in some examples refers to sensing measurements that are communicated, such that they can be discerned and interpreted by a 5GS (e.g., the data is communicated using a standard protocol to an interface defined by the 5GS).

The term “accuracy of positioning estimate” at least in some examples refers to a KPI that describes the closeness of the measured sensing result (e.g., position and/or the like) of the target object to its true position value. In some examples, the accuracy of positioning estimate can be derived or divided into a horizontal sensing accuracy (e.g., referring to the sensing result error in a 2D reference or horizontal plane or “x-axis” in a Cartesian coordinate system) and a vertical sensing accuracy (e.g., referring to the sensing result error on the vertical axis or altitude, and/or the “y-axis” in a Cartesian coordinate system). Additionally or alternatively, the accuracy of positioning estimate can be further derived or divided into a depth sensing accuracy (e.g., referring to the sensing result error on the “z-axis” in a Cartesian coordinate system).

The term “accuracy of velocity estimate” at least in some examples refers to a KPI that describes the closeness of a measured sensing result (e.g., velocity and/or the like) of a target object's velocity to its true velocity.

The term “confidence level” at least in some examples refers to a KPI that describes the percentage of all the possible measured sensing results that can be expected to include the true sensing result considering the accuracy.

The term “sensing resolution” at least in some examples refers to a KPI that describes the minimum difference in the measured magnitude of target objects (e.g., range, velocity, and/or the like) to be allowed to detect objects in different magnitude.

The term “missed detection probability” at least in some examples refers to a KPI that describes a conditional probability of not detecting the presence of target object/environment when the target object/environment is present. In some examples, the missed detection probability is denoted by a ratio of the number of events falsely identified as negative over (to) the total number of events with a positive state. In some examples, the missed detection probability applies only to binary sensing results. Additionally or alternatively, an event with a positive state refers to the presence of the characteristics of a target object or environment, including the event falsely identified as being negative and truly identified as being positive

The term “false alarm probability” at least in some examples refers to a KPI that describes a conditional probability of falsely detecting the presence of target object/environment when the target object/environment is not present. In some examples, the false alarm probability is denoted by the ratio of the number of events falsely identified as being positive over (to) the total number of events with a negative state. In some examples, the false alarm probability applies only to binary sensing results. Additionally or alternatively, an event with a negative state refers to the non-presence of the characteristics of a target object or environment, including the event falsely identified as being positive and truly identified as being negative.

The term “maximum sensing service latency” or “max sensing service latency” at least in some examples refers to a KPI that describes the time elapsed between the event triggering the determination of the sensing result and the availability of the sensing result at the sensing system interface.

The term “refreshing rate” or “refresh rate” at least in some examples refers to a KPI that describes the rate at which a sensing result is generated by a sensing system. In some examples, the refreshing rate is the inverse of the time elapsed between two successive sensing results. In some examples, the term “refreshing rate” and the term “update rate” can be used interchangeably.

The term “analytics” at least in some examples refers to the discovery, interpretation, and communication of meaningful patterns in data. Additionally or alternatively, the term “analytics” at least in some examples refers to the systematic computational analysis of data or statistics. For purposes of the present disclosure, the term “analytics” may refer to the process or techniques used to perform analytics and/or analysis on data, or a data structure including or indicating a result of performing the analytics processes or techniques.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN, feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), attention and/or self-attention mechanisms, and/or the like.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. Additionally or alternatively, the term “machine learning model” or “ML model” at least in some examples refers to a mathematical algorithm that can be “trained” by data (or otherwise learn from data) and/or human expert input as examples to replicate a decision an expert would make when provided that same information. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably. The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model” represents a data-generating process.

The term “machine learning entity” or “ML entity” at least in some examples refers to an entity that is either an ML model or contains an ML model and ML model-related metadata that can be managed as a single composite entity. In some examples, metadata may include, for example, the applicable runtime context for the ML model. The term “AI decision entity”, “machine learning decision entity”, or “ML decision entity” at least in some examples refers to an entity that applies a non-AI and/or non-ML based logic for making decisions that can be managed as a single composite entity.

The term “machine learning training”, “ML training”, or “MLT” at least in some examples refers to capabilities and associated end-to-end (e2e) processes to enable an ML training function to perform ML model training (e.g., as defined herein). In some examples, ML training capabilities include interaction with other parties/entities to collect and/or format the data required for ML model training. The term “machine learning model training” or “ML model training” at least in some examples refers to capabilities of an ML training function to take data, run the data through an ML model, derive associated loss, optimization, and/or objective/goal, and adjust the parameterization of the ML model based on the computed loss, optimization, and/or objective/goal. The term “machine learning training function”, “ML training function”, or “MLT function” at least in some examples refers to a function with MLT capabilities.

The term “AI/ML inference function” or “ML inference function” at least in some examples refers to a function (or set of functions) that employs an ML model and/or AI decision entity to conduct inference. Additionally or alternatively, the term “AI/ML inference function” or “ML inference function” at least in some examples refers to an inference framework used to run a compiled model in the inference host. In some examples, an “AI/ML inference function” or “ML inference function” may also be referred to an “model inference engine”, “ML inference engine”, or “inference engine”.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1.-21. (canceled)

22. A method of operating a service producer, the method comprising:
receiving, from a service consumer, a first message including an analytics identifier (ID) that corresponds to a sensing service and a set of input parameters related to the sensing service;
obtaining analytics information based on the analytics ID and the set of input parameters; and
sending, to the service consumer, a second message including the analytics information.

23. The method of claim 22, wherein the analytics ID is “Analytics ID: sensing channel frequency response” and the analytics information includes:
a channel frequency response for individual transmit (Tx) beam directions over one or more resource elements (REs) used for sensing signal transmission;
the one or more REs used for the individual Tx beam directions including potential beam repetitions within a symbol repetition interval (SRI).

24. The method of claim 23, wherein the set of input parameters includes one or more of: a set of Tx modulation symbols of one or more transmitted sensing signals; a set of Rx modulation symbols of one or more received echo signals; and a set of interpolation parameters or windowing parameters.

25. The method of claim 22, wherein the analytics ID is “Analytics ID: Range-Doppler image” and the analytics information includes: a range-Doppler image for individual Tx beam directions; a range fast Fourier transform (FFT) size; and a Doppler FFT size.

26. The method of claim 25, wherein the set of input parameters includes one or more of:
a channel frequency response for individual Tx beam directions over one or more REs used for sensing signal transmission; and
the one or more REs used for the individual Tx beam directions including potential beam repetitions within an SRI.

27. The method of claim 22, wherein the analytics ID is “Analytics ID: Range-Doppler image after beam integration” and the analytics information includes: a range-Doppler image taken after beam integration for individual Tx beam directions; a range FFT size; and a Doppler FFT size.

28. The method of claim 27, wherein the set of input parameters includes one or more of: a range-Doppler image taken after for individual Tx beam directions; the range FFT size; the Doppler FFT size; and a number of beam repetitions for each beam within an SRI.

29. The method of claim 22, wherein the analytics ID is “Analytics ID: Delay-Doppler bins after CFAR” and the analytics information includes: one or more delay-Doppler bins in a two dimensional (2D) grid that have a predetermined constant false alarm rate (CFAR) and are likely to contain target objects; a range FFT size; and a Doppler FFT size.

30. The method of claim 29, wherein the set of input parameters includes one or more of: a range-Doppler image taken after beam integration for individual Tx beam directions; the range FFT size; the Doppler FFT size; and a set of CFAR processing parameters.

31. The method of claim 25, wherein the range-Doppler image is a 2D periodogram calculated over a delay-Doppler grid, wherein the delay-Doppler grid has a grid size of the range FFT by the Doppler FFT.

32. The method of claim 22, wherein the analytics ID is “Analytics ID: Detected targets in FoV” and the analytics information includes: a set of detected target objects in an field of view (FoV); and for each detected target object in the set of detected target objects: an existence detection, a range, a velocity, and angle information.

33. The method of claim 32, wherein the set of input parameters includes one or more of: one or more delay-Doppler bins in a two dimensional (2D) grid that have a predetermined constant false alarm rate (CFAR) and are likely to contain target objects; a range FFT size; a Doppler FFT size; and an angular resolution algorithm and corresponding parameters for the angular resolution algorithm.

34. The method of claim 33, wherein the angular resolution algorithm is estimation of signal parameters via rotational invariant techniques (ESPRIT), multiple signal classification (MUSIC), constant modulus algorithm (CMA), Capon method, Minimum Variance Distortionless Response (MVDR), Maximum Likelihood Estimation (MLE), iterative sparse asymptotic minimum variance (SAMV), Very-Long-Baseline Interferometry (VLBI), or Expectation-Maximization (EM) algorithm.

35. The method of claim 23, wherein the set of input parameters includes one or more of: a field of view (FoV); a maximum desired detection range; a maximum desired detection velocity; a range resolution; a velocity resolution; an angle resolution; a sensing frame duration; a sensing radio bandwidth; a number and index of symbols in a frame used for signal transmission; a number and index of subcarriers in a bandwidth used for signal transmission; a number of Tx antenna elements; a number of Tx ports; a number of Rx antenna elements; a number of Rx ports; and the individual Tx beam directions to cover the FoV within the SRI.

36. The method of claim 22, wherein the analytics information is generated based on collected data related to the sensing service.

37. The method of claim 36, wherein the collected data related to the sensing service includes one or more of raw received signal measurements, received signal power measurements, or received signal quality measurements, noisy time-variant frequency-selective channel frequency response for individual Tx beam directions, periodograms, results of CFAR processing, a set of delay-Doppler bins for individual Tx beams, and results of angular resolution processing of delay-Doppler bins.

38. The method of claim 36, wherein the collected data related to the sensing service is collected by one or more radio access networks (RANs) or a sensing service management function (SSMF).

39. The method of claim 22, wherein the first message is a analytics subscription message based on invocation of an Nnwdaf_AnalyticsSubscription_Subscribe service operation, and the second message is a notification message based on invocation of an Nnwdaf_AnalyticsSubscription_Notify service operation.

40. The method of claim 22, wherein the first message is a analytics request message based on invocation of an Nnwdaf_AnalyticsInfo_Request service operation service operation, and the second message is a response message based on the invocation of the Nnwdaf_AnalyticsInfo_Request service operation service operation or a Nnwdaf_AnalyticsInfo_Response service operation service operation.

41. The method of claim 22, wherein the service consumer is an SSMF, a data collection coordination function (DCCF), a Messaging Framework Adaptor Function (MFAF), an Application Function (AF), or a Network Exposure Function (NEF).

42. The method of claim 22, wherein the service producer is a Network Data Analytics Function (NWDAF), an NWDAF containing an analytics logical function (AnLF), a DCCF, an MFAF, an AF, an NEF, or an SSMF.
